(19) United States
(12) Patent Application Publication
(10) Pub. No.: US 2026/0259158 A1
(43) Pub. Date: Sep. 3, 2026

(54) Method and Apparatus for Quantifying Thermal Conductivity and Specific Heat Capacity of Subsurface Geologic Formations

(71) Applicants: Lawrence Corlies Murdoch, Anderson, SC (US); Atlas Energy, LTC. CO., LLC, Columbia, SC (US)

(72) Inventors: Patrick David Duff, Columbia, SC (US); Lawrence Corlies Murdoch, Anderson, SC (US)

(21) Appl. No.: 19/547,400

(22) Filed: Feb. 23, 2026

Related U.S. Application Data
(60) Provisional application No. 63/765,176, filed on Feb. 28, 2025.

(51) Int. Cl. G01N 25/18; G01K 1/14; G01K 11/3206; G01N 25/00; H05B 3/12

(52) U.S. Cl. CPC G01N 25/18; G01K 1/14; G01K 11/3206; G01N 25/005; H05B 3/12

(57) ABSTRACT

A method, device, and system for quantifying thermal properties of subsurface geologic materials are disclosed, addressing challenges in geothermal energy applications. The method involves deploying an array of temperature sensors and heating elements encapsulated within an inflatable sleeve into a borehole, activating the heating elements to inject heat into the enveloping formation, and measuring a time series of temperature data for subsequent analysis. The device includes an array of temperature sensors, at least one heater element, a power source, and an interrogator configured to measure temperature using data from the sensors. The system incorporates the inflatable sleeve with fiber optic sensors defining a fiber Bragg grating, heating elements, a power source, and a computing unit programmed to perform numerical inversion for calculating thermal conductivity and specific heat capacity, thereby optimizing borehole heat exchanger designs for geothermal heat pump systems.

### CROSS REFERENCE TO PRIOR APPLICATIONS

This application claims priority and benefit under 35 U.S.C. § 119(e) from U.S. Provisional Application No. 63/765,176, filed Feb. 28, 2025, which is incorporated by reference for all purposes.

### BACKGROUND

### Technical Field

This disclosure relates generally to geothermal energy technologies, and more particularly to methods and devices for quantifying thermal properties of subsurface geologic formations.

### Background Art

The technology associated with geothermal heat pumps integrated with borehole heat exchangers, which leverage the relatively stable temperatures of subsurface formations, is increasingly viewed as a high-efficiency alternative for building heating and cooling. Accurate knowledge of the distribution of thermal conductivity and specific heat capacity in the subsurface is necessary for properly sizing borehole heat exchangers and predicting long-term performance.

The most common approach for in-situ characterization of ground thermophysical properties employs thermal response tests on completed borehole heat exchangers, which inject a constant thermal power into the ground and monitor fluid temperatures at the heat exchanger inlet and outlet over an extended period—typically several days—to estimate an effective thermal conductivity. However, data from such tests relies on simplifying assumptions regarding uniform heat flux with depth, homogeneous material properties, and predominantly conductive heat transfer, which may lead to significant uncertainties in the estimated parameters.

Although widely used for large-scale projects, such thermal response tests require dedicated borehole heat exchanger installations, specialized equipment, and lengthy field campaigns that drive up installation and operational costs. Furthermore, the averaging involved in fluid temperature measurements obscures depth-specific variations in thermal properties and prevents direct estimation of subsurface heat capacity. Accordingly, it would be advantageous to have more streamlined testing methods that reduce time and expense while providing reliable, depth-resolved estimates of thermophysical properties to support better design and reduce performance risks associated with geothermal heat pump systems.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory system in accordance with one or more embodiments of the disclosure.

FIG. 2 illustrates a sectional view of one explanatory device in accordance with one or more embodiments of the disclosure.

FIG. 3 illustrates a sectional view of another explanatory device in accordance with one or more embodiments of the disclosure.

FIG. 4 illustrates another explanatory electronic device in accordance with one or more embodiments of the disclosure.

FIG. 5 illustrates explanatory system components in accordance with one or more embodiments of the disclosure.

FIG. 6 illustrates one explanatory method in accordance with one or more embodiments of the disclosure.

FIG. 7 illustrates temperature measurements made on a wall of an insulated borehole in response to a heat pulse in accordance with one or more embodiments of the disclosure.

FIG. 8 illustrates a geographical site of interest in accordance with one or more embodiments of the disclosure.

FIG. 9 illustrates a borehole array in accordance with one or more embodiments of the disclosure.

FIG. 10 illustrates one or more embodiments of the disclosure.

FIG. 11 illustrates one or more other embodiments of the disclosure.

FIG. 12 illustrates still other embodiments of the disclosure.

FIG. 13 illustrates one explanatory method in accordance with one or more embodiments of the disclosure.

FIG. 14 illustrates another explanatory method in accordance with one or more embodiments of the disclosure.

FIG. 15 illustrates still another explanatory method in accordance with one or more embodiments of the disclosure.

FIG. 16 illustrates an explanatory device in accordance with one or more embodiments of the disclosure.

FIG. 17 illustrates one explanatory system in accordance with one or more embodiments of the disclosure.

FIG. 18 illustrates still other embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to deploying, into a borehole located at a measurement site of a geographic area of interest, an array of temperature sensors and an array of heating elements encapsulated in a sleeve, activating the array of heating elements to generate a resulting vertical heat distribution in the borehole, and measuring a vertical distribution time series of temperature measurements using the array of temperature sensors. In one or more embodiments, the method steps and apparatus components further comprise deploying another array of temperature sensors into the borehole with the array of temperature sensors and the array of heating elements, wherein the vertical distribution time series of temperature measurements is measured using both the array of temperature sensors and the another array of temperature sensors.

As an illustration, some embodiments reside in combinations of method steps and apparatus components related to deploying, into a borehole located at a geographic site of interest, an array of temperature sensors and an array of heating elements encapsulated in a borehole insertable device housing, placing the device housing on the wall of the borehole in geologic material, activating the array of heating elements to inject heat energy into the wall of the borehole, and measuring temperatures using the array of temperature sensors. The resulting temperatures and injected heat energy are interpreted by inverting one or more appropriate mathematical forward models to determine the distribution of thermophysical properties in the enveloping geologic material. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

It will be appreciated that embodiments of the disclosure described herein may be comprised of one or more conventional processors and unique stored program instructions that control the one or more processors to implement, in conjunction with certain non-processor circuits, some, most, or all of the functions of using one or more processors to query each temperature sensor of a plurality of vertically stacked and horizontally arrayed temperature sensors situated along a borehole insertable device housing after a power source actuates at least one heater element situated along the borehole insertable device housing for a predefined duration to determine a temperature distribution along the borehole insertable device housing and within the wall of the borehole as described herein. The non-processor circuits may include, but are not limited to, a radio receiver, a radio transmitter, signal drivers, clock circuits, power source circuits, and user input devices.

As such, these functions may be interpreted as steps of a method to perform operations such as querying a fiber Bragg grating after a power source actuates at least one heater element to determine a temperature distribution along the length of the flexible sleeve defining a borehole insertable device housing to determine ground thermophysical properties within the wall of the borehole. Alternatively, some or all functions could be implemented by a state machine that has no stored program instructions, or in one or more application specific integrated circuits (ASICs), in which each function or some combinations of certain of the functions are implemented as custom logic.

Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in a figure other than figure A.

As noted above, the field of geothermal energy technologies, particularly ground heat pump systems, has long faced challenges in accurately characterizing subsurface thermal properties, such as thermal conductivity and specific heat capacity, to describe the diffusion of heat in the subsurface. These ground thermophysical properties (GTPs) play a significant role in designing and scaling borehole heat exchangers (BHEs), which serve as the foundation for efficient geothermal heat pump systems.

Conventional methods, such as thermal response tests (TRTs), rely on injecting a constant thermal power into completed BHEs and measuring fluid temperature changes at the BHE inlet and outlet over extended periods. While widely used, these methods suffer from notable limitations, including the fact that temperature is measured in the inlet and outlet locations of the BHE above ground and not in the subsurface geologic formations. These measurements give information on the average heating rate, but not the timing of the arrival of the heating front, thus providing information on thermal conductivity but not specific heat capacity. The problem with conventional TRTs is made worse by the fact that BHEs are typically quite long (deep) and the measurement of thermal conductivity is averaged over the length. Measurements at specific depth-resolved or depth-determined subsurface locations are infeasible using conventional methods.

Modification of testing procedures, such as making more temperature measurements along the borehole or using an inversion scheme to interpret the data, could help address these shortcomings, but such modifications are rarely made. These shortcomings introduce uncertainties in the estimates of thermophysical properties that increase the risk that geothermal heat pumps will fail to function according to their design.

Furthermore, conventional interpretation of TRT data commonly assumes a uniform heat flux with depth, homogeneous material properties, and purely conductive heat transfer. Such assumptions often lead to inaccuracies in estimating thermal conductivity because they fail to account for variations in heat flux with depth, depth-specific variations in thermophysical properties, and heat transport by advection. Conventional TRTs also require dedicated boreholes, making them prohibitively expensive for small-scale applications and impractical for real-time adjustments during system design.

Advantageously, embodiments of the disclosure address these limitations by introducing novel methods, systems, and apparatuses for quantifying subsurface thermal conductivity and specific heat capacity with greater accuracy, precision, and cost-effectiveness. In these embodiments direct time-series measurements of temperature are made in the subsurface at knowns locations in response to precise active heating. in one or more embodiments, temperature measurements are made by applying an electrical resistance heater and multiple temperature sensors on the wall of a boring. The locations of the temperature sensors are precisely registered relative to the heater. When activated, the heater injects heat at a known rate or thermal power. Injecting heat increases the temperature in the vicinity of the heater. The heating front arrives at points close to the heater soon after the heating starts, but the heating front takes longer to reach points that are farther away.

The heat flux during a temperature change depends on the thermal conductivity, but the timing of when the temperature change occurs and the magnitude of the temperature change depend on the thermal conductivity and specific heat capacity. Data that record the heating rate, and the timing, and magnitude of the temperature change, along with the geometry of the instrumentation can be inverted to estimate the thermophysical properties at the depth of the heater when heat transfer occurs by conduction. The configuration of the heater and the temperature sensors can be repeated at multiple depths or distances along the borehole so that the thermal properties can be quantified as a function of depth. Temperature measurements made on either side of a heater can also be used to estimate advective heat transfer caused by flowing water in the geologic material adjacent to the boring.

The heaters and temperature sensors can be embedded within a flexible sleeve that extends along the length of the borehole and that is the same diameter as or slightly larger than the borehole. The heaters and temperature sensors are pushed against the wall of the borehole during deployment, and they are removed from the borehole for possible reuse after a test is complete.

Embodiments of the disclosure may place the array of temperature sensors and at least one heating element at appropriate angular positions around the circumference of the flexible sleeve, all at the same distance along the sleeve, and use these instruments to infer subsurface thermophysical properties by measuring a temperature time series in response to active heating of the wall of the borehole. The instruments defined by the array of temperature sensors and the heating element are spatially registered with one another and with the device housing and form one measurement location in a series of measurement sites located along the borehole insertable flexible sleeve.

Embodiments of the disclosure address limitations of conventional TRTs in that measurements of the heating rate, and timing, and magnitude of temperature changes are measured directly in the geologic formation at determined subsurface locations, obviating the need for length-averaging and permitting estimation of specific heat capacity as well as thermal conductivity. Furthermore, because temperature measurements are made at depth-determined locations in response to precise active heating, the assumption of uniform heat flux is unnecessary and variations in material properties with depth and heat transport by advection can be considered. The sleeve can be retrieved so the borehole can be used for other purposes. This reduces costs compared to requiring a complete BHE for conventional testing which makes TRTs more accessible for small-scale applications and makes possible adjustments to the size of BHEs during system design.

In one or more embodiments, a deployable borehole package comprises a flexible sleeve encapsulating a plurality of vertically stacked and horizontally arrayed temperature sensors and heating elements. In one or more embodiments, the sleeve is held against the geologic formation exposed in the wall of a borehole. By activating the heating elements to generate controlled heating at known locations and measuring the resulting temperature time series at multiple depths, the system captures depth-resolved thermal data.

The plurality of temperature sensors and heating elements can be spatially registered to and carried by the sleeve. Vertically stacked corresponds to the orientation of the instrumentation parallel to the long axis of the sleeve, while horizontally arrayed corresponds to an orientation orthogonal to the long axis of the sleeve or around the circumference of the cross section of the sleeve.

In one or more embodiments, advanced numerical inversion methods are then applied to interpret the temperature data and simultaneously quantify thermal conductivity and specific heat capacity as a function of depth. Unlike conventional TRTs, this approach eliminates the need for completed BHEs, reduces field time, and provides reliable, depth-specific thermal property estimates.

In one or more embodiments, the described technology further incorporates precision fiber Bragg grating (FBG) sensors or alternative high-resolution temperature sensors, such as platinum resistance thermometers, enabling accurate detection of changes of transient temperature. The flexible sleeve design facilitates deployment in various borehole configurations and depths, ranging from shallow residential applications to deep geothermal projects.

Additionally, the system's modular architecture allows for integration with computational models and algorithms to optimize data analysis and system design. By addressing the limitations of traditional methods, the disclosed approach significantly enhances the scalability, reliability, and economic feasibility of geothermal heat pump systems, paving the way for broader adoption in residential, commercial, and industrial applications.

In one or more embodiments, a method for quantifying thermal conductivity and specific heat capacity within the wall of a borehole involves deploying an array of vertically stacked and horizontally arrayed temperature sensors and heating elements encapsulated within a flexible sleeve at a measurement site in a geographic area of interest. In one or more embodiments, the heating elements are activated to apply controlled heating of known power, while the temperature sensors record a time-series of measurements of the temperature distribution along the borehole.

These measurements capture the thermal response of the surrounding subsurface material to the applied heat. Using advanced numerical inversion methods, the recorded temperature data is analyzed to simultaneously determine the thermal conductivity and specific heat capacity as a function of depth. This approach enables precise characterization of ground thermophysical properties, facilitating the accurate scaling and monitoring of borehole heat exchangers for geothermal heat pump systems.

Advantageously, the deployment of an array of temperature sensors and heating elements encapsulated in a sleeve into a borehole enables precise measurement of thermal properties directly within the subsurface environment. By encapsulating the sensors and heating elements within a sleeve, the system ensures consistent positioning and alignment of the components, minimizing external disturbances and optimizing thermal contact with the surrounding geological material. This arrangement facilitates the generation of a controlled heat distribution when the heating elements are activated, allowing for the creation of a predictable temperature field along the borehole.

The subsequent measurement of a time series of the temperature distribution using the array of temperature sensors provides depth-resolved temperature data. Unlike conventional methods that rely on fluid temperature measurements in completed borehole heat exchangers, this approach directly captures the thermal response of the geological formation itself. This eliminates inaccuracies associated with averaging over large lengths and assumptions of homogeneous material properties, thereby improving the reliability of the thermal conductivity and specific heat capacity estimations. Moreover, while some recent systems collect temperature data in a borehole to obtain depth-specific estimates of thermal conductivity, these systems, unlike embodiments of the present disclosure, fail to provide (1) depth-resolved thermal data of heating and the resulting temperature change, (2) controlled heating (location, timing, and power of heating), (3) the ability to estimate depth-resolved thermal conductivity and specific heat capacity.

Furthermore, the encapsulated design reduces the complexity and duration of field operations by enabling streamlined deployment and retrieval of the system. This makes the method more cost-effective and accessible for both small-scale and large-scale geothermal applications. The ability to measure thermal properties at multiple depths simultaneously enhances the resolution of the data, supporting better design and scaling of borehole heat exchangers for geothermal heat pump systems.

In one or more embodiments, a device is designed to measure and analyze subsurface thermal properties by deploying an inflatable flexible sleeve into a borehole at depths ranging from 0.05 to three kilometers below the surface of a geographic area of interest. In one or more embodiments, an inflatable sleeve defines a device housing. In one or more embodiments, the sleeve houses a stacked plurality of co-depth-registered heating elements and temperature sensors, including a fiber Bragg grating (FBG) system comprising optical fiber sensors. In other embodiments, the FBG system can be replaced with a system of thermistors. Coiled or wrapped DTS fiber could also be used.

In one or more embodiments, the active heating array, constructed from nickel-chromium wire heating elements, generates controlled heating within the sleeve and borehole wall where the electricity passing through the nickel-chromium produces the heat. In one or more embodiments, a fiber Bragg grating interrogator, operatively coupled to the optical fiber sensors, queries the FBG system to detect temperature distributions resulting from the applied heating.

It should be noted that the nickel-chromium heating element(s) could be formed into different configurations to create heat sources of different geometries, including point-source heating elements (bundled-wire), or line-source heating elements (unbundled, continuous-wire). Since a line can be considered an infinite set of points, the heating element(s) could be points, lines, or both.

In one embodiment, a short section of nickel-chromium wire is used to create a heat source representing a point. In this context a section of nickel-chromium wire is considered to represent a point source if the length of the wire is smaller than 1/10 the distance to the nearest temperature sensor. In another embodiment, the nickel-chromium wire is coiled into a tight circular spiral within the sleeve to create a planar circular heat source. In another embodiment, the nickel-chromium wire is long compared to the distance to the nearest temperature sensor, and it is parallel to the long axis of the borehole and represents a straight line source. In another embodiment, the nickel-chromium wire is long relative to the distance to the nearest temperature sensor and it extends along all or part of the circumference.

In one or more embodiments, these temperature measurements are recorded by a data logger onto a non-transient, computer-readable medium, enabling precise determination of the distribution of thermal conductivity and specific heat capacity. This configuration facilitates high-resolution thermal property analysis, supporting the accurate scaling and monitoring of borehole heat exchangers for geothermal applications.

Advantageously, the arrangement of vertically stacked and horizontally arrayed temperature sensors and at least one heater element within a borehole insertable device housing enables precise measurement of the distribution of transient temperature along the borehole. By situating the temperature sensors and heater element in a co-registered configuration along the device housing, the device ensures accurate spatial correlation between the heat source and the temperature measurement points. This spatial arrangement minimizes errors caused by misalignment and enhances the reliability of the recorded temperature data.

The integration of a power source with the heater element advantageously allows controlled activation of the heating element for a predefined duration, ensuring consistent thermal perturbations within the wall of the borehole. This controlled heating facilitates the generation of a predictable temperature field, which is necessary for analyzing subsurface thermal properties.

The inclusion of an interrogator operatively coupled to the temperature sensors enables real-time querying of temperature data. This functionality allows the device to capture transient temperature changes resulting from the applied heating, providing high-resolution data necessary for determining vertical and horizontal temperature distributions. The geometry of the FBG (or other temperature measurement instrument) clusters allows for a temperature distribution to be measured horizontally, across the co-deregistered heater and group of temperature sensors, and vertically, where the heating front arriving from heaters within instrument clusters located vertically adjacent up and down the borehole sleeve is recorded. Advantageously, the ability to record these distributions along the borehole insertable device housing supports the accurate characterization of subsurface thermal conductivity and specific heat capacity.

Furthermore, the encapsulation of the components within the borehole insertable device housing ensures their protection from external disturbances, such as mechanical vibrations or environmental factors, thereby maintaining the integrity of the measurements. This design also facilitates streamlined deployment and retrieval of the device, reducing operational complexity and field time.

In one or more embodiments, a system for evaluating ground thermophysical properties, as described, comprises an inflatable sleeve that carries fiber optic cables defining fiber Bragg grating (FBG) temperature sensors extending along the length of the sleeve parallel to the central axis of the sleeve. In one or more embodiments, the sleeve also incorporates at least one heating element positioned strategically between the FBG sensors to ensure precise thermal measurements.

In one or more embodiments, a power source is operatively coupled to the heating element, enabling controlled activation to generate a predictable temperature field in the vicinity of the heater within the sleeve and borehole wall. Additionally, in one or more embodiments the system includes an interrogator operatively connected to the FBG, which queries the fiber optic sensors to detect temperature distributions resulting from the applied heating.

In one or more embodiments, the interrogator transmits the temperature data to a computing unit, which executes advanced numerical inversion methods to determine thermal conductivity and specific heat capacity parameters along the length of the sleeve. This configuration facilitates high-resolution analysis of subsurface thermal properties, supporting the accurate design, scaling, and monitoring of borehole heat exchangers for geothermal applications.

Advantageously, the inflatable sleeve carrying a fiber optic sensor defining a fiber Bragg grating (FBG) and at least one heating element situated along the sleeve enables precise measurement of temperature distributions within a borehole. By positioning the heating element between optical fiber sensors of the FBG, the system ensures accurate thermal interaction between the heat source and the temperature sensors, facilitating the generation of a predictable temperature field along the sleeve. This arrangement minimizes spatial misalignment and enhances the reliability of temperature data collected during active heating.

The integration of a power source operable with the heating element allows controlled activation of the heating element with known power and timing and at known locations within the wall of the borehole, ensuring consistent thermal perturbations. This controlled heating plays a significant role in generating the depth-specific heating fronts necessary for analyzing subsurface thermal properties. The interrogator operatively connected to the FBG queries the fiber optic sensors to detect transient temperature changes resulting from the applied heating, providing high-resolution data required for determining temperature distributions.

The system's configuration supports depth-resolved analysis of ground thermophysical properties, such as thermal conductivity and specific heat capacity, by leveraging the known power, timing, and locations of the heating elements and the precise temperature data obtained from the FBG sensors. This depth-specific characterization eliminates inaccuracies associated with conventional methods that rely on averaged measurements over large depths, thereby improving the reliability of subsurface thermal property estimations.

Additionally, the inflatable sleeve design facilitates deployment in various borehole configurations and depths, ranging from shallow residential applications to deep geothermal projects. The sleeve's flexibility and encapsulation of components protect the sensors and heating elements from external disturbances, such as mechanical vibrations or environmental factors, ensuring the integrity of the measurements. This streamlined deployment and retrieval process reduces operational complexity and field time, making the system more cost-effective and accessible for geothermal applications.

Other advantages will be described below. Still others will be obvious to those of ordinary skill in the art having the benefit of this disclosure.

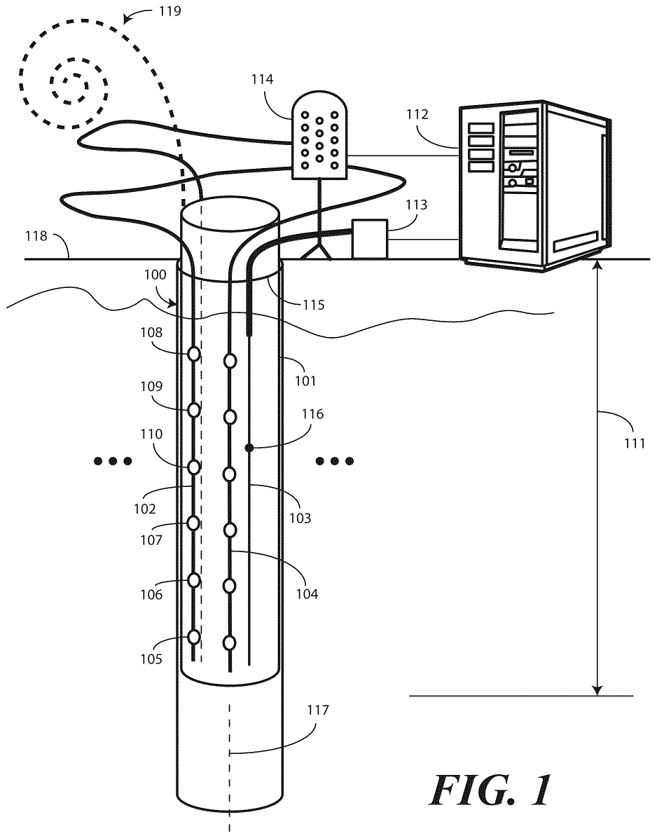

Turning now to FIG. 1, illustrated therein is one explanatory system in accordance with one or more embodiments of the disclosure. As illustrated in FIG. 1, a device 100 in accordance with one or more embodiments of the disclosure has been situated in a borehole 115 at a measurement site within a geographic area of interest. In one or more embodiments, the device 100 is operable to measure and analyze subsurface thermal properties by deploying an inflatable sleeve 101 into the borehole 115.

In one or more embodiments, the device 100 comprises an inflatable flexible sleeve 101. In one or more embodiments, the inflatable sleeve 101 can be manufactured using polyethylene or Tyvek.sup.TM tubing to ensure durability, flexibility, and cost-effectiveness.

Polyethylene, a thermoplastic polymer, offers strong resistance to environmental stressors such as moisture and temperature variations, making polyethylene suitable for subsurface applications. Tyvek.sup.TM, a synthetic material composed of high-density polyethylene fibers, provides additional benefits such as lightweight construction, tear resistance, and chemical inertness, which are advantageous for deployment in boreholes.

In one or more embodiments, the inflatable sleeve 101 can be fabricated by bonding or welding two sheets of the selected material. Illustrating by example, the illustrative device 100 of FIG. 1 comprises a stacked plurality of co-depth-registered heating elements, e.g., heating element 116, defined by a nickel-chromium wire 103 and one or more temperature sensors 105,106,107,108,109,110 defined by fiber optic cables 102,104. In this example, the these temperature sensors 105,106,107,108,109,110 define a fiber Bragg grating.

As used herein, a fiber Bragg grating (FBG) represents a type of optical sensor embedded within a fiber optic cable. This sensor facilitates the measurement of variations in temperature, strain, or other physical parameters by examining the behavior of light propagating through the fiber. Thus, in the context of FIG. 1, temperature sensors 105,106,107,108,109, 110 are each defined by such optical sensors. In accordance with embodiments of the disclosure, fiber Bragg gratings are utilized as high-accuracy temperature sensors to assess subsurface thermal characteristics, including thermal conductivity and specific heat capacity, within a borehole.

In the context of FIG. 1, a fiber Bragg grating is a small, periodic structure etched into the central region of an optical fiber, e.g., optical fiber 102 or optical fiber 104. This structure functions as a filter that reflects specific wavelengths of light while permitting others to pass through. The wavelength of light that is reflected is influenced by the spacing of the periodic structure, referred to as the grating period. When the fiber is subjected to variations in temperature or strain, the grating period adjusts, modifying the wavelength of the reflected light. By observing these adjustments, the FBG can accurately measure temperature or strain.

The process of creating a fiber Bragg grating involves modifying the refractive index of the central region of the fiber optic cable at regular intervals. This is typically done using ultraviolet (UV) light.

The process beings with fiber preparation. A standard optical fiber is selected, which consists of a central region (where light travels), a cladding (to confine the light within the central region), and a protective coating.

The fiber then undergoes ultraviolet (UV) light exposure. The fiber is exposed to a high-intensity UV laser beam through a mask or an interferometric setup. The mask or setup creates a pattern of alternating high and low UV intensity along the length of the fiber. In one or more embodiments, the UV light alters the refractive index of the central region of the fiber in the exposed areas, creating a periodic pattern. This pattern forms the grating structure. The periodic changes in the refractive index act as a filter that reflects specific wavelengths of light, forming the fiber Bragg grating.

In the context of the described technology, FBGs are integrated into the flexible sleeve 101 that is deployed into a borehole 115. The inflatable sleeve 101 contains an array of temperature sensors 105,106,107,108, 109,110, including FBGs, and heating elements 116 defined by nickel-chromium wire 103. The FBGs are positioned along the length of the inflatable sleeve 101 to measure temperature changes at multiple depths.

The fiber Bragg grating contributes to the system of FIG. 1 by providing precision temperature measurement. FBGs detect transient temperature changes caused by the activation of heating elements 116. These measurements are highly accurate, with resolutions in the centi-Kelvin to milli-Kelvin range.

Unlike conventional methods that average temperature over large depths, FBGs provide depth-resolved temperature data. This, in combination with the heating fronts generated with known timing at known locations by heating elements of known power, allows for precise characterization of subsurface thermal properties.

The temperature data collected by the FBGs is analyzed in the computing device 112 using advanced numerical inversion methods to calculate thermal conductivity (k_{T}) and specific heat capacity (cₚ) as a function of depth. FBGs are robust and require low power, making them suitable for long-term deployment in boreholes. Their ability to provide continuous sampling enhances the reliability of the measurements.

The advantages of using fiber Bragg gratings in the system of FIG. 1 are many. Illustrating by example, FBGs can detect minute temperature changes, which is important for achieving accurate estimations of subsurface thermal properties.

The fiber optic cables 102,104 defining the FBGs are lightweight and easy to integrate into the flexible sleeve 101. Moreover, FBGs provide temperature measurements at specific, known locations along the fiber, avoiding issues with distance averaging seen in other systems like distributed temperature sensing (DTS). What's more, the FBG-based system can be adapted for various borehole depths and configurations, ranging from shallow residential applications to deep geothermal projects.

In summary, fiber Bragg gratings are a significant element of the proposed system, enabling precise, depth-specific measurement of subsurface thermal properties. Their integration into the flexible sleeve enhances the precision, operational effectiveness, and economic feasibility of the proposed method for quantifying ground thermophysical properties.

Accordingly, in one or more embodiments the inflatable sleeve 101 can be fabricated by bonding or welding two sheets of the selected material so as to encapsulate the heating elements and temperature sensors 105,106,107,108,109,110 securely. Where used, this encapsulation ensures proper alignment and protection of the components during deployment and operation.

In one or more embodiments, the inflatable sleeve 101 may also be tailored to match specific borehole dimensions, with seams reinforced to prevent leakage or deformation under pressure. By leveraging these materials, the inflatable sleeve achieves the required mechanical properties to withstand subsurface conditions while maintaining ease of deployment and retrieval.

In one or more embodiments, the system further includes a power supply 113 that is operable with the heating element 116. A computing device 112 can serve as a data logger that is operatively coupled to a fiber Bragg grating interrogator 114. In one or more embodiments, the computing device 112 is configured to analyze the recorded data.

In this illustrative embodiment, the device 100 is situated at a depth 111 below the surface 118 of a geographic area if interest in the borehole 115 at a depth 111 of between 0.05 and three kilometers. Being so situated, the temperature sensors 105,106,107,108,109,110 of the device 100 function to record a time-series temperature record in response to active heating by the heating element 116. With this data, the computing device 112 is configured to determine the distribution of thermal conductivity and specific heat capacity of the geologic formations adjacent to the borehole 115.

In one or more embodiments, the inflatable sleeve 101 serves as the housing for the device 100 and is constructed from flexible polyethylene material. The illustrative inflatable sleeve 101 is designed to encapsulate the heating element 116 and the fiber optic cables 102,104, which define the fiber Bragg grating temperature sensors 105,106,107,108,109,110.

In some embodiments, the sleeve 101 is manufactured from at least two sheets of polyethylene, with the nickel-chromium wire heating element 103 and the fiber optic cables 102,104 sandwiched between the sheets and oriented parallel to the central axis 117 of the inflatable sleeve 101. Additionally, in one or more embodiments the inflatable sleeve 101 can be rolled into a coil 119 for deployment into the borehole 115.

Thereafter, the inflatable sleeve 101 can be inflated and optionally filled with a thermally insulative material to guide propagation of the heating front created by the heating element of known power and to ensure proper contact with the borehole walls. The inflatable sleeve 101 facilitates deployment in various borehole configurations and depths, ranging from shallow residential applications to deep geothermal projects.

In one or more embodiments, the fiber optic cables 102,104 are components of the device 100, carrying the fiber Bragg grating defined by the temperature sensors 105,106,107,108,109, 110. In one or more embodiments, the fiber optic cables 102, 104 extend along the length of the inflatable sleeve 101 and run parallel to the central axis 117 of the inflatable sleeve.

In this illustrative embodiment, the fiber optic cables 102,104 and are optically coupled to the fiber Bragg grating interrogator 114, which is operable to query the fiber Bragg grating to detect temperature distributions resulting from active heating of the heating element 116. In some embodiments, the fiber optic cables 102,104 are positioned at predetermined intervals around the perimeter of the inflatable sleeve 101 to generate temperature measurements in response to active heating at discrete intervals along the length of the inflatable sleeve 101.

In one or more embodiments, the heating element 116 is constructed from nickel-chromium wire 103 and is carried by the inflatable sleeve 101. The nickel-chromium wire can be bundled to form a point-source heating element, or a continuous length of nickel-chromium wire can serve as a line-source heating element. The heating element 116 is positioned relative to the temperature sensors along fiber optic cables 102,104 and is operatively coupled to the power supply 113.

In one or more embodiments, the power supply 113 delivers a predetermined amount of power to the heating element 116 for a predefined duration. When activated the heating element generates a temperature field and heating front that propagates away from the element with time. The resulting temperature change propagates upward and outward warming the enveloping geologic material and creating a temperature distribution within the wall of the borehole. This controlled activation, that generates a predictable, repeatable temperature field within the wall of the borehole 115, facilitates the analysis of subsurface thermal properties.

In one or more embodiments, the fiber Bragg grating is defined by the temperature sensors 105,106,107,108,109,110 carried by the inflatable sleeve 101. These temperature sensors 105,106,107,108,109,110 are distributed along the length of the fiber optic cables 102,104 and are co-depth-registered with the heating element 116. The fiber Bragg grating interrogator 114 queries the temperature sensors 105,106,107,108,109,110 to detect transient temperature changes resulting from the applied heating. In some embodiments, the temperature sensors 105,106,107,108,109,110 are spaced between 0.01 and 100 meters apart to ensure precise measurement of temperature distributions along the 115.

In one or more embodiments, the power supply 113 is operatively coupled to the heating element 116 and is configured to deliver a predetermined amount of power to the heating element 116 for a predefined duration. Accordingly, this controlled activation ensures consistent thermal perturbations within the wall of the borehole 115, facilitating the generation of a predictable temperature field necessary for analyzing subsurface thermal properties.

In one or more embodiments, the computing device 112 serves as a data logger that is operatively coupled to the fiber Bragg grating interrogator 114 and is configured to record the temperature data obtained from the fiber Bragg grating defined by the temperature sensors 105,106,107,108,109,110. The data logger stores the recorded temperature data onto a non-transient, computer-readable medium, enabling precise determination of the distribution of thermal conductivity and specific heat capacity.

In one or more embodiments, the computing device 112 is configured to receive temperature data from the fiber Bragg grating interrogator 114 and execute advanced numerical inversion methods to determine thermal conductivity and specific heat capacity parameters along the length of the inflatable sleeve 101. The computing device 112 analyzes the recorded temperature data by solving a corresponding mathematical model that includes thermal conductivity and specific heat capacity as unknown variables.

In one or more embodiments, the coil 119 is formed by rolling the inflatable sleeve 101 for streamlined deployment into the borehole 115. The coil 119 facilitates transportation and insertion of the sleeve 101 into the borehole 115, ensuring proper alignment and positioning of the heating element 116 and temperature sensors 105,106,107,108,109,110.

In one or more embodiments, the borehole 115 serves as the subsurface environment into which the device 100 is deployed. The borehole 115 is located at a measurement site within a geographic area of interest and ranges in depth from 0.05 to three kilometers below the surface 118. The borehole 115 provides the geological formation against which the inflatable sleeve 101 is positioned to measure thermal properties.

In one or more embodiments, the surface 118 represents the upper boundary of the geographic area of interest where the borehole 115 is located. The device 100 is deployed into the borehole 115 beneath the surface 118 to record temperature data and analyze subsurface thermal properties.

In one or more embodiments, the depth 111 refers to the vertical distance below the surface 118 of the geographic area of interest at which the device 100 is deployed. The depth 111 ranges from 0.05 to three kilometers, inclusive, and plays a significant role in determining the distribution of thermal conductivity and specific heat capacity within the wall of the borehole 115. It should be noted that while depth 111 is a vertical depth, embodiments of this disclosure are envisioned for use not only in vertical boreholes but also in those that are not vertical and could be inclined or horizontally oriented with respect to the ground surface. In the case of an inclined borehole the angle of inclination and the distances of the co-registered temperature sensors and heating elements along the length of the sleeve or borehole can be used to determine the thermophysical properties as a function of depth. In the case of a horizontal borehole, the distances of the co-registered temperature sensors and heating elements along the length of the sleeve or borehole can be used to determine the thermophysical properties at the depth of the borehole as a function of the distance along the length of the borehole.

The system of FIG. 1 relies upon the fact that the conduction of heat in the subsurface depends on the distribution of thermal properties according to the following equation:

$$α = \frac{{k}_{T}}{ρ {c}_{p}} \qquad ( EQ . 1 )$$

In this expression, α is thermal diffusivity, kris thermal conductivity, ρ is density, and cₚ is specific heat capacity. The product ρcₚ is volumetric specific heat capacity. The distribution of thermal conductivity and specific heat capacity has important implications for the performance of borehole heat exchangers because these thermal properties control the rate at which heat can be exchanged and the amount of thermal energy that can be stored.

Knowing these ground thermophysical properties as a function of depth is important when designing and scaling ground heat pump systems because errors will increase costs. Errors in thermal properties that cause heat pumps to under-perform will require heating or cooling systems to be retro-fitted for additional expense. Errors that cause heat pumps to be over-designed will create systems that are larger and more expensive than needed. Both cases cause heat pumps to cost more than they should. This has slowed the adoption of this important technology.

To address this problem, embodiments of the disclosure contemplate that engineers estimate effective thermal conductivity by analyzing results from in-situ experiments. Current practice involves performing some variation of the thermal response test. In its simplest form, a thermal response test imposes a constant heat flux on a completed borehole heat exchanger for 48 to 100 hours, and the fluid temperature is measured as a function of time. The temperature data are analyzed using analytical or numerical methods, but the assumptions used in most analyses, for example uniform heat flux with depth and purely conductive heat transport, can lead to significant errors in the estimated thermal properties. Moreover, limited and indirect temperature measurements in the subsurface can restrict the thermal properties that can be resolved—k_{T} is estimated but cₚ is assumed using typical methods.

Thermal response tests require a dedicated borehole and completion, and they can require significant time in the field. As a result, only large-scale projects can afford to conduct thermal response tests, and they are out of reach for small-scale ground heat pump systems. Moreover, the errors involved with conventional tests call into question their value even in large-scale applications; and because such tests must be performed in completed borehole heat exchangers, if test results determine that the exchanger is inappropriately sized, corrective action cannot be taken without undue expense, that is, the size of the exchanger cannot be modified.

Geothermal heat pumps paired with borehole heat exchangers are a key technology for reducing costs associated with heating and cooling. The factors outlined above increase costs and reduce effectiveness of geothermal heat pumps and that stands in the way of their widespread application.

With this in mind, in the context of the system of FIG. 1, a device 100 is deployed into a borehole 115 at a measurement site within a geographic area of interest to quantify simultaneously, in the borehole 115, the distribution of thermal conductivity and specific heat capacity as ground thermophysical properties for the correct scaling and/or monitoring of borehole heat exchangers. In one or more embodiments, the device 100 implements a deployable borehole package containing a discrete distributed array of temperature sensors 105,106,107,108,109,110 and an array of active heating elements, e.g., heating element 116, encapsulated in an inflatable sleeve 101. In one or more embodiments, data are measured simultaneously at multiple depths and then analyzed using advanced mathematical methods executed by a computing device 112 to determine the distribution of k_{T} and cₚ within depth 111.

In one or more embodiments, ground thermophysical properties are evaluated by measuring the temperature response to a known input of heat produced by a heating element 116 that is implemented with nickel chromium wire 103 carried by the inflatable sleeve 101. Injecting heat creates a consistent, repeatable temperature field or thermal perturbation that raises the temperature in the vicinity of the heating element 116 and this temperature change propagates outward laterally and vertically in the enveloping geologic material.

In one or more embodiments, the heating front arrives at points close to the heating element 116 soon after the heating starts, but the heating front takes longer to reach points that are farther away. The rate of the temperature change at a particular location depends on k_{T}, but the timing of when the temperature change occurs depends on both k_{T} and cₚ. The classic approach to estimate k_{T} and cₚ is to measure the temperature response some distance away from a heater operating at a known power. The rate and timing of the temperature signal, along with the distance from the heater, can be used to estimate the thermal properties.

In FIG. 1, the system for quantifying ground thermophysical properties couples the heating element 116 and multiple temperature sensors 105,106,107,108,109,110 on the wall-adjacent side of the inflatable sleeve 101 positioned within the borehole 115. As a non-limiting explanatory example, consider a cross-section of the borehole 115 with the nickel chromium wire 103 that defines the heating element 116 located near one azimuthal position and the temperature sensors 105,106,107,108,109, 110 carried by fiber optic cables 102 and 104 at other azimuthal positions around the inflatable sleeve 101. In one or more embodiments, the borehole 115 may be filled around the sleeve 101 with insulating material to reduce axial and internal convective losses.

Activating the heating element 116 with a known thermal power supplied by the power supply 113 creates a temperature field that conducts through the surrounding rock or soil. Little heat is conducted into the interior of the sleeve 101, especially when filled with thermally insulative material. Instead, the heat conducts outward and sequentially warms each of the temperature sensors 105,106,107,108, 109,110.

In one or more embodiments, the heating rate and maximum temperature are functions of the thermal properties, so assuming a density value for the geologic formation, measurements of temperature can be inverted by the computing device 112 to estimate k_{T} and cₚ at that depth 111. A representative density value for a given geologic formation can be assumed from prior knowledge, such as the lithology of the given formation, density measurements of the formation made in boreholes located nearby, a measured density value from the same borehole, or can be inferred from other geophysical information such as gravity or seismic surveys. The configuration of the heating element 116 and temperature sensors 105,106,107,108,109,110 is repeated along the inflatable sleeve 101 parallel to a central axis 117 so the thermal properties can be characterized as a function of depth 111.

The instrument configuration described above can be deployed by rolling the inflatable sleeve material into a coil 119, unrolling the coil 119 and lowering extended sections of the inflatable sleeve 101 into the borehole 115. Thereafter, the inflatable sleeve 101 can be inflated against the formation. As noted above, the inflatable sleeve 101 can be fabricated from low-cost polyethylene or Tyvek.sup.TM tubing.

In one or more embodiments, the nickel-chromium wire 103 is bonded or welded along the length of the inflatable sleeve 101 at discrete points, or a continuous length of nickel-chromium wire is bonded or welded along the length of the inflatable sleeve, and the fiber optic cables 102,104 carrying the temperature sensors 105,106,107,108,109,110 are bonded at appropriate angular positions around the inflatable sleeve 101 such that the sensors are co-depth-registered with the heating element 116. After the thermal property test is complete, the inflatable sleeve 101 can be depressurized and retrieved from the borehole 115.

In a non-limiting example, the system uses distributed, discrete temperature sensors 105,106,107,108,109,110 created using precision fiber Bragg gratings carried by the fiber optic cables 102,104. This approach depicted in FIG. 1 is not to be confused with distributed temperature sensing, where temperatures are averaged over a meter or more along the length of an optical fiber. The method implemented by device 100 requires electronics that are simpler than distributed temperature sensing systems, and the locations of the measurements are known precisely, so problems with distance averaging are avoided. As an alternative to fiber Bragg gratings, a variety of temperature sensors, such as precision thermistors, could be used for this application without departing from embodiments of the disclosure.

In a non-limiting example of a method suitable for execution by the system of FIG. 1, a simulation was conducted to demonstrate the system's operation. The simulation assumed heat transfer by conduction in two dimensions using a six-inch diameter boring with a geometry similar to the top view of the conceptual model. The analysis used thermal properties typical of granite for the rock and typical of expanded perlite for the borehole annulus.

A 20-W heat source was set at one azimuth on the wall of the boring, analogous to the heating element 116 implemented with nickel chromium wire 103, and temperature sensors were set at multiple azimuths analogous to the temperature sensors 105,106,107,108,109,110 carried by fiber optic cables 102,104. The heat source was activated for two hours through the power supply 113 and allowed to cool for ten hours, and the resulting equations were solved using Galerkin finite elements.

The heater raised the temperature by approximately 10° C., according to the simulations. The heat conducted into the rock, but the insulated borehole region is slower to heat up so the temperature contours wrap around the borehole 115. The temperature at the measurement points increases during heating and reaches a peak a few minutes to hours after the heating stops depending on the location. The analysis was repeated after increasing k_{T} by 30 percent and cₚ by 20 percent.

The temperature time-series for the baseline properties is distinctly different from the time-series for the modified k_{T} and cₚ. Time series like these can be resolved using high-precision temperature sensors, including precision fiber Bragg gratings, and these sensors are sufficient to measure clearly the differences in the time-series resulting from different thermal properties. Using models like the one shown here with a numerical inversion method implemented by the computing device 112 can discriminate between the time series. This indicates that it is feasible to measure the temperatures caused by modest heating using the device 100 in the borehole 115 and to interpret the data using inversion methods to identify k_{T} and cₚ.

The primary application of this system is to estimate k_{T} and cₚ as a function of depth 111 using the claimed deployment of the inflatable sleeve 101 carrying the fiber optic cables 102, 104 and the nickel chromium wire 103 defining the heating element 116, the controlled powering by the power supply 113, the interrogation of temperature by a fiber Bragg interrogator 114, and the subsequent inversion by the computing device 112. Additional applications include characterization of advective or convective heat transfer by operating a small, short-duration heating element 116 with a symmetric array of temperature sensors 105,106,107,108,109,110, so that the temperature in the downstream direction would increase faster than in the upstream direction.

It also would be feasible to install a borehole heat exchanger after testing with the instrumented sleeve 101. In that case, the borehole 115 would be filled with thermal grout after the heat exchanger was emplaced, allowing the temperature distribution over the borehole to be measured in detail to evaluate performance and to monitor the exchanger over its lifetime, while the claim-recited measurement and inversion workflow remains applicable to depth-resolved evaluation of thermal properties. Other applications for the system of FIG. 1 will be obvious to those of ordinary skill in the art having the benefit of this disclosure.

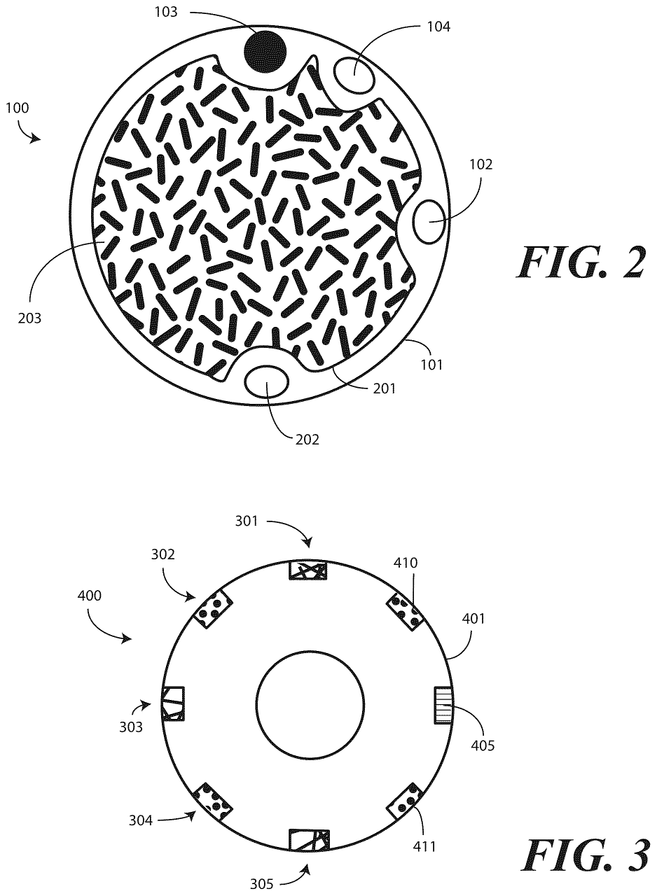

Turning now to FIG. 2, illustrated therein is a sectional view of the device 100 of FIG. 1. In one or more embodiments, the device 100 comprises a borehole-insertable sensor system configured to quantify subsurface thermal properties, including thermal conductivity and specific heat capacity.

In one or more embodiments, the heating and temperature sensing components of the device 100 are encapsulated within an inflatable sleeve 101 serving as the housing for internal components. In one or more embodiments, the device 100 is configured for deployment into boreholes ranging from shallow residential applications to deep geothermal projects, with operational depths between approximately 0.05 and 3.0 kilometers below surface.

Accordingly, the device 100 integrates controlled heating elements defined by nickel-chromium wire 103, precision temperature sensors defined by fiber optic cables 102,104, and optional insulation, to facilitate accurate measurement of subsurface thermal properties. For example, in a residential geothermal heat pump installation, the device 100 can be deployed to a depth of 100 meters to characterize the thermal conductivity profile before finalizing the borehole heat exchanger design.

In one or more embodiments, this configuration results in the inflatable sleeve 101 forming the outer housing of the device 100, wherein the sleeve 101 is constructed from durable, flexible materials such as polyethylene or Tyvek.sup.TM. The sleeve 101 is designed to expand and conform to borehole walls upon inflation, thus ensuring consistent thermal contact with surrounding geological material.

In this illustrative embodiment, the sleeve 101 encapsulates internal components—including the nickel-chromium wire 103, fiber optic cables 102,104, and optional insulation 203—thereby protecting them from external disturbances such as mechanical vibrations or environmental factors. The sleeve 101 can be fabricated by bonding or welding two sheets of the selected material, with seams reinforced to prevent leakage or deformation under subsurface pressure. In a use case involving a deep geothermal exploration well, the inflatable sleeve 101 can be custom sized to match the borehole diameter and inflated at 1,500 meters depth to ensure optimal sensor contact with the formation.

In one or more embodiments, the interior layer of polyethylene 201 provides structural strength and thermal stability to the inflatable sleeve 101. Polyethylene is selected due to its resistance to environmental stressors-such as moisture and temperature variations-making this material appropriate for subsurface applications. The interior layer of polyethylene 201 supports the integrity of the inflatable sleeve 101 during deployment and operation while functioning as a protective barrier for internal components. For instance, in a field test conducted in a high-moisture environment, the polyethylene layer 201 prevents water ingress and maintains the mechanical integrity of the inflatable sleeve throughout the measurement campaign.

Illustratively, the nickel-chromium wire 103 functions as the heating element within the device 100. The nickel-chromium wire 103 is strategically positioned along the length of the inflatable sleeve 101 to generate controlled thermal perturbations within the wall of the borehole.

In one embodiment, the nickel-chromium wire 103 is bundled or knotted to optimize heat distribution and is operatively coupled to a power source to deliver a predefined power level over a specified duration. Thus, the heating elements thereby defined are co-depth-registered with temperature sensors defined by the fiber optic cables 102,104,202 to ensure accurate spatial correlation between the heat source and measurement points.

Nickel-chromium wire 103 is recognized for its high resistivity and durability, making the wire particularly suited for subsurface heating applications. For example, in a laboratory calibration scenario, the nickel-chromium wire 103 is activated for two hours to generate a 10° C. temperature rise, allowing for validation of the temperature sensor response and the inversion algorithm.

Likewise, in one or more embodiments the fiber optic cables 102,104,202 house fiber Bragg grating (FBG) temperature sensors distributed along the inflatable sleeve 101. These cables are positioned at predetermined intervals around the perimeter of the inflatable sleeve 101 so as to measure temperature changes at multiple distances, and axial displacements from the nickel-chromium wire 103, along the wall of the borehole.

The fiber optic cables 102,104,202 are lightweight and flexible, allowing for seamless integration into the sleeve 101. The embedded FBG sensors provide high-resolution temperature data, thereby enabling precise characterization of subsurface thermal properties. The cables are optically coupled to a fiber Bragg grating interrogator, which queries the sensors to detect transient temperature changes resulting from active heating. In a use case involving a municipal geothermal field, the fiber optic cables 102,104,202 are spaced at 10-meter intervals along a 300-meter sleeve to provide a detailed vertical profile of thermal conductivity and specific heat capacity.

However, in certain embodiments optional insulation 203 is introduced as a thermally insulative material—such as expanded perlite or sand—filling the interior of the inflatable sleeve 101. The insulation 203 minimizes axial and convective heat losses, ensuring that heat generated by the nickel-chromium wire 103 is directed outward into the surrounding geological formation. This controlled heat distribution contributes to improved measurement accuracy and subsequent analysis of thermal conductivity and specific heat capacity.

Furthermore, the insulation 203 provides structural support to the sleeve 101, preventing collapse under subsurface pressure. For example, in a test conducted in unconsolidated sand, the sleeve 101 is filled with expanded perlite as insulation 203 to maintain the shape of the sleeve and to ensure that the majority of the heat flows radially into the formation rather than axially along the borehole.

In one or more embodiments, the construction of the device 100 involves the following steps: (1) Material Selection-polyethylene or Tyvek.sup.TM sheets are bonded or welded to encapsulate internal components securely; (2) Sensor and Heater Integration—the fiber optic cables 102,104,202 with FBG sensors are positioned at angular intervals around the sleeve 101, while the nickel-chromium wire 103 is bonded along the sleeve's length; (3) Insulation—the sleeve 101 may be filled with optional insulation 203 to enhance thermal performance and structural rigidity; and (4) Deployment Mechanism—the sleeve 101 is rolled into a coil for transportation and, once inserted into the borehole, is inflated to ensure proper contact with borehole walls. In a rapid site assessment use case for a commercial building, the device 100 is assembled offsite, transported as a compact coil, and deployed in a 50-meter test borehole, where the sleeve 101 is inflated and filled with sand as insulation 203 before initiating the heating and measurement sequence.

Accordingly, in one or more embodiments the device 100 is used as follows: (a) Deployment—the device 100 is lowered into the borehole via a drop weight or other suitable mechanism, and the sleeve 101 is inflated to conform to borehole walls, ensuring consistent thermal contact; (b) Heating and Measurement—the nickel-chromium wire 103 is activated to generate a controlled heat distribution, while the fiber optic cables 102, 104,202 record a time series of temperature measurements at multiple depths; (c) Data Analysis-recorded temperature data is transmitted to a computing device that applies advanced numerical inversion methods to quantify thermal conductivity and specific heat capacity as functions of depth; and (d) Applications—the device 100 can be employed for geothermal heat pump system design, borehole heat exchanger monitoring, and subsurface thermal property characterization, and can be adapted for convective heat transfer analysis by incorporating additional sensors and heaters. For example, in a research application, the device 100 is used to characterize the thermal properties of a test site before and after groundwater injection to study the effects of forced convection on subsurface heat transport.

In one or more embodiments multiple configurations are provided: (i) Single Column Configuration—in which the fiber optic cables 102,104,202 and nickel-chromium wire 103 are arranged in a single column along the sleeve 101, yielding a linear thermal measurement profile; (ii) Multi-Column Configuration—where multiple columns of fiber optic cables and heating elements are distributed radially around the sleeve 101, enabling circumferential temperature measurements for enhanced spatial resolution; (iii) Point Source Heating—the nickel-chromium wire 103 is configured as discrete point sources along the sleeve 101 to allow localized heating and precise thermal analysis; (iv) Continuous Line Heating—the nickel-chromium wire 103 is arranged as a continuous line source along the sleeve 101 to provide uniform heat distribution for large-scale applications; and (v) Insulated vs. Non-Insulated—the sleeve 101 may be filled with optional insulation 203 for enhanced thermal performance or left unfilled for direct contact with borehole walls.

By leveraging these configurations, the device 100 affords flexibility and adaptability for a wide range of subsurface thermal property measurement applications. For instance, in a quality assurance scenario for a geothermal installation, the multi-column configuration is used to detect circumferential variations in thermal conductivity that could indicate heterogeneity in the formation or grout.

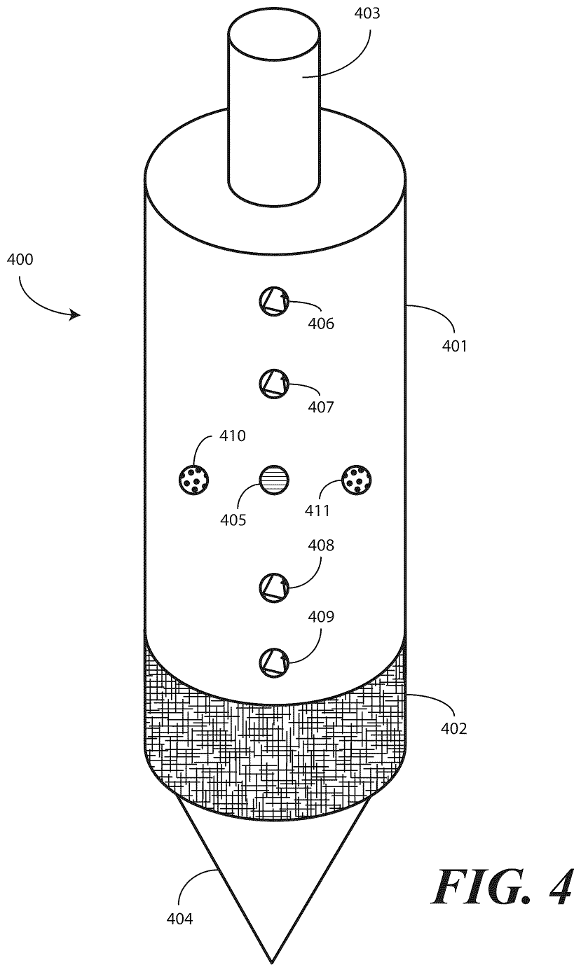

Turning now to FIG. 4, illustrated therein is another explanatory electronic device 400 configured in accordance with one or more embodiments of the disclosure. The electronic device 400 of FIG. 4 is an alternate to the device (100) of FIG. 1 that can be used for evaluating ground thermophysical properties.

In one or more embodiments, a borehole insertable device housing 401 serves as the primary structural component of the device 400. In one or more embodiments, the housing 401 encapsulates all internal elements, including temperature sensors 406,407,408,409, heater element 405, and insulation layers.

In one or more embodiments, the housing 401 is configured to withstand subsurface pressures and environmental conditions, thereby ensuring the structural integrity of the device 400 during deployment and operation. Accordingly, the housing 401 can be constructed from durable materials such as polyethylene or steel, providing flexibility and robustness for deployment in boreholes ranging from shallow residential applications to deep geothermal projects. Furthermore, the housing 401 is designed to carry a stacked plurality of co-depth-registered heating elements 405 and temperature sensors 406,407,408,409, ensuring precise spatial alignment for accurate thermal measurements.

In some embodiments, a steel tube 403 is positioned at the top of the borehole insertable device housing 401 and serves as a connector for deploying and retrieving the device 400. The steel tube 403 provides structural support and facilitates the attachment of external components, such as connection cable, which links the device 400 to the control unit. Under ordinary conditions, the steel tube 403 is designed to withstand mechanical stresses during insertion and retrieval, thereby ensuring the stability of the borehole insertable device 400 throughout the operational lifecycle.

There can be a need for an insertion cone 404 at the bottom of the borehole insertable device housing 401. In one or more embodiments the insertion cone 404 is tapered to reduce resistance during deployment and ensure proper alignment of the device 400 within the borehole. Where included the insertion cone 404 also aids in positioning the device 400 against the borehole walls, which enhances thermal contact for precise measurements.

In one or more embodiments, a permeable screen 402 surrounds the lower portion of the borehole insertable device housing 401 and serves as a protective layer for the internal components. The permeable screen 402 is configured to allow heat transfer while preventing external debris or contaminants from interfering with the operation of heater element 405 and temperature sensors 406,407,408,409. Accordingly, the permeable screen 402 ensures consistent thermal gradients and protects the device 400 from environmental disturbances.

In this illustrative embodiment, the vertically stacked temperature sensors 406,407,408,409 are distributed along the length of the borehole insertable device housing 401. Each sensor is registered with heater element 405 to ensure accurate spatial correlation between the heat source and measurement points.

In some embodiments, each temperature sensor 406,407,408,409 records transient temperature changes resulting from active heating, thereby providing high-resolution data for determining temperature distributions. The temperature sensors 406,407,408,409 are spaced at predetermined intervals to generate temperature measurements at discrete depths, supporting depth-resolved analysis of thermal conductivity and specific heat capacity.

In one or more embodiments, the heater element 405 is constructed from nickel-chromium wire and is positioned within the borehole insertable device housing 401. The heater element 405 is operatively coupled to a power supply, which delivers a predetermined amount of power for a predefined duration in one or more embodiments. This controlled activation generates a predictable temperature field within the wall of the borehole, facilitating the analysis of subsurface thermal properties. Furthermore, the heater element 405 is registered with temperature sensors 406,407,408,409 to ensure precise alignment and reliable measurements.

Accordingly, the circumferential temperature sensors 410,411 are positioned in the middle of the borehole insertable device housing 401 on either side of the heater element 405, each being distributed radially around heater element 405 and, therefore, circumferentially around the borehole insertable device housing 401. These sensors are designed to measure temperature variations at different azimuthal positions, providing circumferential data for enhanced spatial resolution. Thus, circumferential temperature sensors 410,411 enable the characterization of thermal properties in multiple directions, supporting comprehensive analysis of subsurface heat transfer.

The illustrative device 400 of FIG. 4 incorporates borehole insertable device housing 401, steel tube 403, insertion cone 404, permeable screen 402, vertically stacked temperature sensors 406,407,408,409, heater element 405, and circumferential temperature sensors 410,411. In one or more embodiments, the device 400 is designed to quantify subsurface thermal properties, including thermal conductivity and specific heat capacity, by deploying into borehole and recording a time series of measurements of the temperature distribution. The device 400 can be operatively coupled to a control unit, power supply, and data processing unit, which analyze the recorded data using advanced numerical inversion methods.

In one or more embodiments, the device 400 comprises a plurality of vertically stacked temperature sensors 406,407,408,409 and at least one heater element 405 carried by borehole insertable device housing 401. A power supply (113) is operable with heater element 405, and an interrogator (114) is operable with temperature sensors 406,407,408,409. Accordingly, the interrogator (114) queries each temperature sensor 406,407,408,409 after power supply 113 actuates heater element 405 for a predefined duration to determine a temperature distribution along borehole insertable device housing 401.

In one or more embodiments, each temperature sensor 406,407,408,409 incorporates a fiber optic sensor defining a fiber Bragg grating. In one or more embodiments, the heater element 405 consists of a wire heating element constructed from bundled nickel-chromium wire. In the illustrative embodiment of FIG. 4, the wire heating element 405 and fiber optic sensors extend along the length of the borehole insertable device housing 401 parallel to the central axis of the housing 401.

Turning now to FIG. 3, which shows a cross section of device 400, in one or more embodiments the temperature sensors 301,303,305 comprise at least two columns (like that shown in FIG. 4 with four temperature sensors 406,407,408,409) with at least two temperature sensors in each column, wherein the columns are arranged along the length of borehole insertable device housing 401 at radially displaced locations from heater element 405. Moreover, the device 400 further comprises circumferential temperature sensors 410,411,302,304 that are radially displaced from heater element 405 on borehole insertable device housing 401. Two such circumferential temperature sensors (410,411) are shown in FIG. 4 as well.

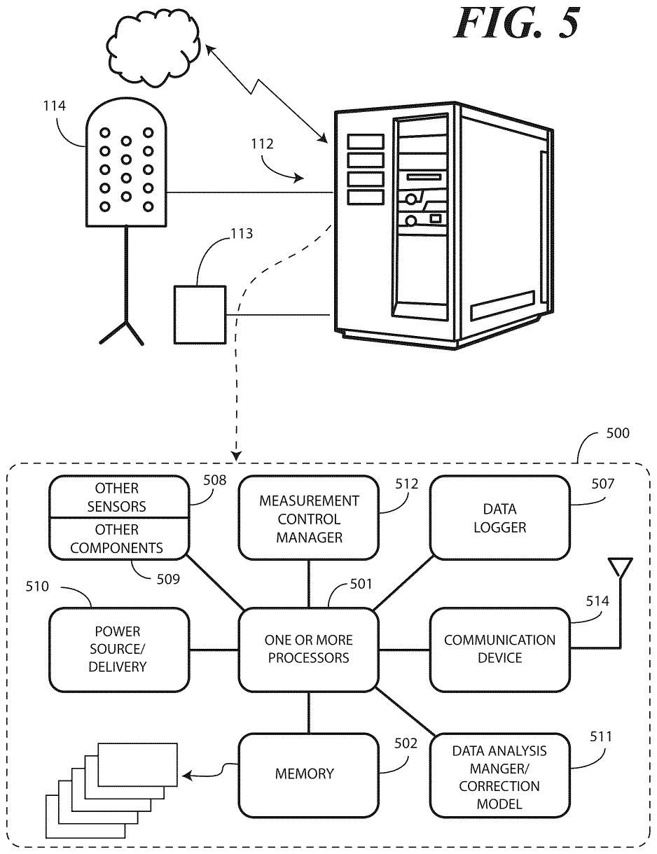

Turning now to FIG. 5, illustrated therein is a system diagram for a computing device 112 configured to manage and process temperature data collected from the borehole-deployable device (100) and associated instrumentation. A schematic block diagram 500 of the computing device 112 is also shown.

In this embodiment, the computing device 112 integrates multiple components for the acquisition, control, correction, and analysis of temperature distributions recorded by temperature sensors, in response to controlled heating generated by heating element powered by power supply 113 and queried via a fiber Bragg interrogator 114, thereby enabling quantification of thermal conductivity and specific heat capacity as a function of depth in boreholes.

In one or more embodiments, the system includes one or more processors 501 that serve as the central processing units for executing instructions and managing system operations. When in operation, these processors 501 are operatively coupled to a memory 502 which stores computer-readable instructions, program modules, and data structures necessary for the system's function. In some embodiments, the memory 502 comprises both volatile and nonvolatile storage media, such as RAM, ROM, flash memory, and other storage technologies, ensuring the retention of data and program instructions during system operation.

In one or more embodiments, the processors 501 are configured to receive temperature data streams from fiber Bragg interrogator 114, which queries fiber optic cables carrying the fiber Bragg grating defined by temperature sensors situated along a device housing, and to synchronously control power supply 113 that actuates heating element, which can be implemented with nickel chromium wire.

In one or more embodiments, a data analysis manager/correction model 511 is employed to process the time series of temperature measurements collected along central axis of a device. In this regard, the data analysis manager/correction model 511 can optionally adjust the temperature profiles for instrumentation timing, performs detrending and denoising, and applies numerical inversion methods to solve a corresponding mathematical model that includes thermal conductivity and specific heat capacity as unknown variables.

Furthermore, in some embodiments this module compensates for measurement artifacts related to deployment and equilibration, thereby isolating the subsurface thermal response attributable to controlled heating. The corrected data is then utilized to calculate thermal property parameters along a depth, which can be further processed to generate depth-resolved profiles indicative of the distribution of thermal conductivity and specific heat capacity within the geological formation intersected by a borehole.

In another aspect, a measurement control manager 512 is operable with fiber Bragg interrogator 114 and power supply 113 to coordinate the collection of measurement data and the application of heating. By virtue of this coordination, heater actuation by power supply 113 and sensor interrogation by fiber Bragg interrogator 114 are properly synchronized in time, and the data acquisition process is optimized for both accuracy and efficiency. In one embodiment, the measurement control manager 512 executes predefined heating sequences, records the corresponding temperature transients from temperature sensors, and issues commands to begin, maintain, and terminate power delivery to heating element based on protocol parameters.

In addition, a user interface is provided to facilitate interaction between the system and the operator. Typically, the user interface comprises graphical displays, touch-sensitive input devices, or alternative mechanisms for providing real-time feedback and control of the system's operations. Thus, the operator is enabled to monitor sensor status from fiber optic cables, adjust heater power and duration delivered by power supply 113, initiate fiber Bragg interrogator 114 queries, and review preliminary data outputs in the form of temperature distributions as a function of distance along a borehole.

In one or more embodiments, a communication device 514 is included to enable the system to transmit and receive data to and from external systems, such as remote servers or cloud-based platforms. In some embodiments, the communication device 514 supports both wired and wireless communication protocols—including RF, infrared, and network-based connections—to ensure seamless integration with the other components of the measurement infrastructure. The communication device 514 can stream temperature measurement datasets and associated heater actuation logs for archival and advanced analysis.

Moreover, in one or more embodiments the system is powered by a power source/delivery module 510 which can be operable to supply energy to all components of the computing device 112. For example, the power source/delivery module 510 may include batteries, power converters, or other energy delivery mechanisms to ensure reliable operation even in remote or challenging environments. In certain embodiments, the power source/delivery module 510 also provides regulated power to power supply 113 and fiber Bragg interrogator 114 to ensure stable heater actuation and precise optical interrogation of the fiber Bragg grating of a connected device.

Additionally, other sensors 508 and components 509 may be integrated into the system to enhance functionality. By way of illustration, these additional sensors can include environmental monitoring devices for ambient temperature and barometric pressure, or supplementary geophysical instruments for site characterization. As a result, these components provide auxiliary data that refines the overall analysis and improves the accuracy of subsurface thermal property quantification.

In this illustrative embodiment, the system is designed to operate within a networked environment, thereby enabling integration of data from multiple measurement sites and facilitating the coordination of multi-borehole campaigns. Due to the modular design of the computing device 112, the system can be adjusted to accommodate diverse geological and operational conditions, enhancing its utility as a tool for depth-resolved evaluation of ground thermophysical properties in accordance with the claims.

In addition to the aforementioned components, in one or more embodiments the one or more processors 501 can comprise, but are not limited to, one or more central processing units. A system bus can couple various system components including the memory 502 to the one or more processors 501. The system bus may be any of several types of bus structures including a memory bus or memory controller, a peripheral bus, and a local bus using any of a variety of bus architectures.

The user interface can optionally include graphics hardware, such as for the display of graphical user interfaces, and may be capable of receiving touch-based user input. Depending on the specific physical implementation, one or more of the processors 501, the memory 502, and other components of the computing device 112 can be physically co-located, such as on a single chip. In such a case, some or all of the system bus can be realized as silicon pathways within a single chip structure.

The memory 502 also typically includes computer-readable media, which can include any available media that can be accessed by processors 501 and includes both volatile and nonvolatile media and removable and non-removable media. By way of example, and not limitation, the memory 502 may comprise computer storage media and communication media.

Computer storage media includes media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks or other optical disk storage, magnetic cassettes, magnetic tape, magnetic disk storage or other magnetic storage devices, or any other medium which can be used to store the desired information and which can be accessed by the computing device 112.

One or more modules stored in the memory 502 can comprise computer-readable instructions, data structures, program modules or other data that are executable by processors 501. A basic input/output system containing routines that help transfer information between elements within computing device 112, such as during start-up, can be stored in ROM. RAM typically contains data and/or program modules that are immediately accessible to and/or presently being operated on by processors 501.

The computing device 112 may also include other removable/non-removable, volatile/nonvolatile computer storage media, such as hard disk drives, magnetic tape cassettes, flash memory cards, digital versatile disks, digital video tape, solid state RAM, and solid state ROM. The drives and their associated computer storage media provide storage of computer-readable instructions, data structures, program modules and other data for the computing device 112, including operating systems, other program modules, and program data generated from fiber Bragg interrogator 114 queries and power supply 113 actuation sequences.

The computing device 112 can operate in a networked environment using logical connections to one or more remote computers. In a networked environment, program modules depicted relative to the computing device 112, or portions or peripherals thereof, may be stored in the memory of one or more other computing devices that are communicatively coupled to the computing device 112 through the network.

Although described as a single physical device, the exemplary computing device 112 can be a virtual computing device, in which case the functionality of the above-described physical components, such as processors 501, memory 502, communication device 514, fiber Bragg interrogator 114 interfaces, and power supply 113 controls can be provided by computer-executable instructions executing on distributed physical computing devices, including configurations where specific devices hosting such instructions dynamically change over time depending upon need and availability.

The data logger 507, as illustrated in FIG. 5, plays a role in the operation of the disclosed system for evaluating ground thermophysical properties. Specifically, the data logger is operatively coupled to the fiber Bragg grating interrogator 114 and is configured to record the time-series of temperature measurements obtained from the fiber optic sensors defining the fiber Bragg grating.

This recorded data is stored on a non-transient, computer-readable medium, ensuring the integrity and accessibility of the temperature profiles for subsequent analysis. The data logger facilitates the accurate determination of thermal conductivity (k_{T}) and specific heat capacity (cₚ) as a function of depth by enabling advanced numerical inversion methods to process the temperature data. Furthermore, the data logger supports real-time monitoring and long-term data collection, making it a vital component for optimizing borehole heat exchanger designs and enhancing the scalability and reliability of geothermal heat pump systems.

Accordingly, FIG. 5 depicts an integrated architecture wherein fiber Bragg interrogator 114 acquires depth-indexed temperature data from fiber optic cables carrying temperature sensors along an inflatable sleeve (101) or device housing (401) situated within a borehole. Power supply 113 actuates one or more heating elements, optionally implemented with nickel chromium wire according to predefined test protocols. Computing device 112 processes the resulting temperature distributions to determine thermal conductivity and specific heat capacity profiles as a function of depth, consistent with the claimed methods, devices, and systems.

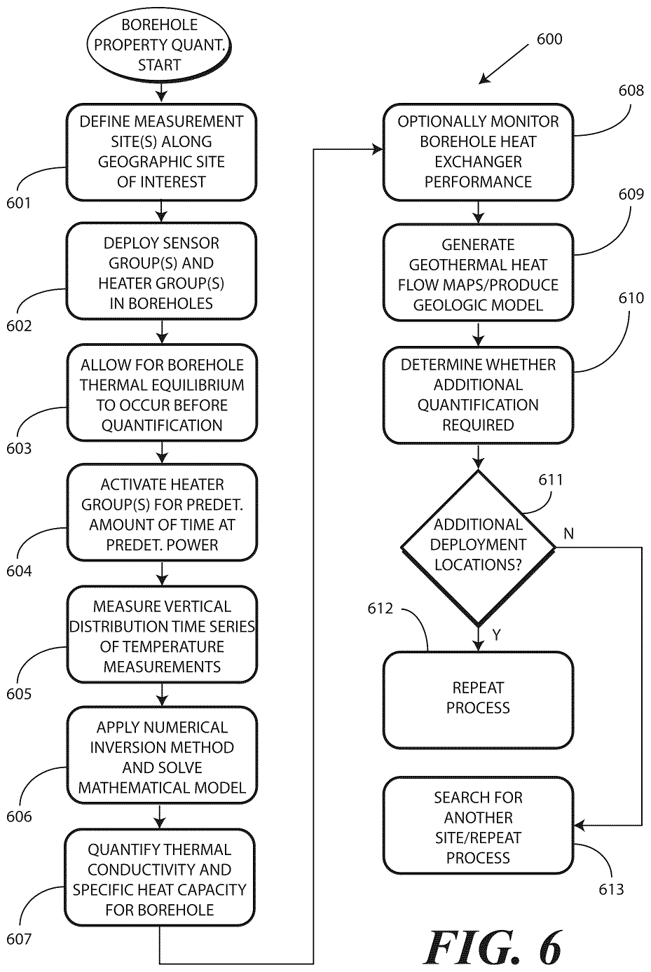

Turning now to FIG. 6, illustrated therein is one such method 600. In one or more embodiments, the method 60 begins at step 601 by defining one or more measurement sites along the geographic site of interest. In one or more embodiments, the process includes identifying these sites based on geological, environmental, or geothermal characteristics that render them suitable for borehole property quantification.

For instance, in a municipal geothermal field, measurement sites may be selected at locations with anticipated subsurface heterogeneity to optimize the design of a borehole heat exchanger array. The measurement site definition further encompasses determining the depth, location, and anticipated subsurface conditions to ensure proper deployment of the sensor groups and heater groups.

In this illustrative embodiment, at step 602, and each defined measurement site, sensor groups and heater groups are deployed in boreholes. In one or more embodiments, each sensor group comprises a plurality of vertically stacked and horizontally arrayed temperature sensors, such as fiber Bragg grating (FBG) sensors, while each heater group includes a vertically stacked array of heating elements, such as bundled nickel-chromium wire. In one or more embodiments, these components are encapsulated within a flexible sleeve and inserted into the borehole.

As a result, co-registration of the sensors and heating elements with the sleeve is achieved to facilitate accurate spatial correlation between heat source and temperature measurement points. In a use case involving a deep geothermal exploration well, the flexible sleeve may be custom sized to match the borehole diameter and deployed to a depth of 1,500 meters to ensure optimal sensor contact with the formation.

Accordingly, after deployment, at step 603 the borehole is optionally allowed to reach thermal equilibrium before quantification. This phase ensures that the subsurface environment stabilizes following the disturbance caused by sensor and heater insertion. For example, in a residential geothermal heat pump installation, the system may be left to equilibrate overnight after deployment to minimize the influence of transient thermal disturbances. Thus, external influences are minimized, and the borehole is prepared for accurate quantification of thermal properties.

Furthermore, in one or more embodiments at step 604 the heater group is activated for a predetermined duration at a predetermined power level to generate a controlled heat distribution within the wall of the borehole. In one or more embodiments, the heating elements are powered for a predefined time and at a known power setting, thereby generating a repeatable temperature field. This controlled heating is necessary for analyzing subsurface thermal response and quantifying both thermal conductivity and specific heat capacity. In a laboratory calibration scenario, the heater group may be activated for two hours to generate a 10° C. temperature rise, allowing for validation of the temperature sensor response and the inversion algorithm.

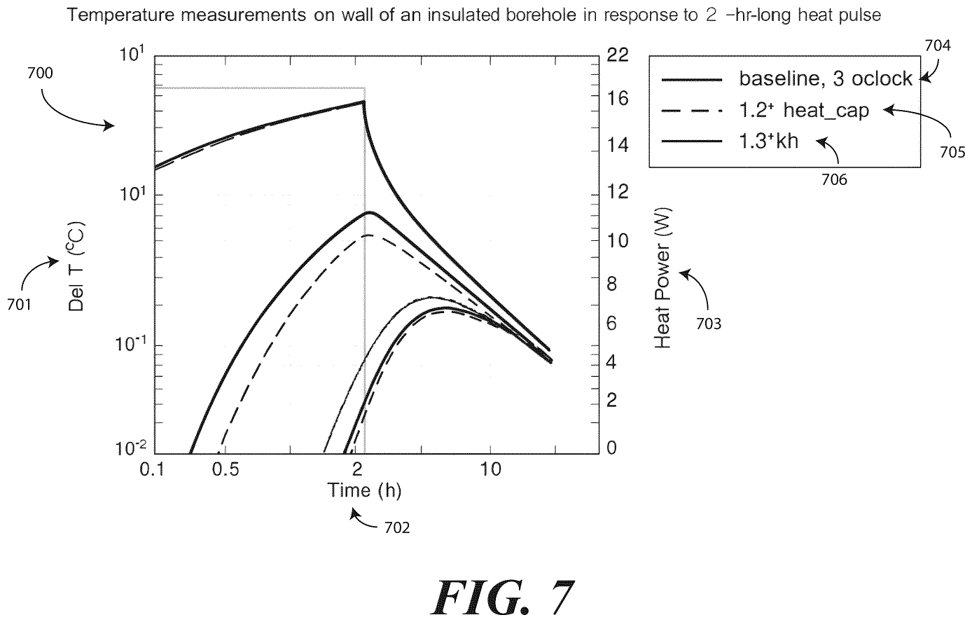

Turning briefly to FIG. 7, illustrated therein is a graph 700 plotting the change in temperature 701 and heat power 703 versus time to show the results of step (604). The graph 700 of FIG. 7 depicting temperature measurements on the wall of an insulated borehole in response to a two-hour-long heat pulse.

In this depiction, the temperature change (ΔT) 701 is plotted against elapsed time 702, with heat power 703 applied during the heating phase. When in the heating phase, the applied heat power 703 elevates the temperature at the borehole wall, and when the heat pulse ceases, the temperature change (ΔT) 701 correspondingly declines over the time axis 702.

By contrast, the graph 700 shows three distinct curves corresponding to varying subsurface thermal property conditions. A baseline measurement at 3 o'clock 704 represents the nominal thermal response of the borehole wall under standard conditions. In one scenario, an increased heat capacity 705 yields a more gradual rise and fall in ΔT, whereas in another scenario, an increased thermal conductivity 706 produces a sharper temperature peak and faster decline. Effectively, these curves represent the thermal response of the borehole wall under varying subsurface thermal property conditions, highlighting the differences in temperature profiles due to changes in heat capacity and thermal conductivity.

Turning now back to FIG. 6, during and after activation of the heater group, at step 605 the sensor group records a time series of measurements of the temperature distribution along the borehole length. These measurements capture the transient thermal response of surrounding geological material to the applied heat. Following this, the recorded data is transmitted to a computing unit for further analysis. For example, in a rapid site assessment for a commercial building, the system may record temperature data at 10-meter intervals along a 50-meter borehole to provide a detailed vertical profile of thermal conductivity and specific heat capacity.

Thereafter, in one or more embodiments at step 606 the temperature time-series data is processed using advanced numerical inversion methods. These methods solve a mathematical model that includes thermal conductivity (k_{T}) and specific heat capacity (cₚ) as unknown parameters. Accordingly, the inversion process interprets the temperature data to quantify subsurface thermal properties. For example, the recorded data may be analyzed using a Bayesian inversion method to estimate parameter uncertainty and to refine the geologic model of the test site.

Thus, the numerical inversion results, at step 607, are used to quantify thermal conductivity (k_{T}) and specific heat capacity (cₚ) as functions of depth within the borehole. These depth-resolved thermal properties play a role in designing and scaling borehole heat exchangers and improving geothermal heat pump systems. For example, in a quality assurance scenario for a geothermal installation, the system may detect circumferential variations in thermal conductivity that could indicate heterogeneity in the formation or grout.

In some embodiments, at step 608, the system can optionally monitor borehole heat exchanger (BHE) performance by analyzing thermal resistance and heat transfer efficiency over time. This optional monitoring ensures optimal operation and longevity of the BHEs. For instance, after a BHE is installed, the system may be used to monitor temperature distributions during seasonal operation to detect changes in subsurface thermal properties or system performance.

Likewise, in one or more embodiments at step 609 the quantified thermal properties are used to generate geothermal heat flow maps and to produce geologic models of the subsurface environment. These outputs provide meaningful insights into the thermal characteristics of the measurement site and support broader geothermal energy applications. In a regional geothermal resource assessment, the system may be deployed at multiple sites to generate a heat flow map that guides the placement of new borehole heat exchangers.

Accordingly, in step 610 the system evaluates whether the collected data are sufficient or if additional quantification is required. This decision is based on the completeness and accuracy of the thermal property measurements and the specific requirements of the project. For example, if the data from a particular borehole indicate heterogeneity that was not anticipated, the system may recommend additional measurements at nearby locations.

In one or more embodiments, decision 611 makes a determination regarding the need for additional deployment locations within the geographic area of interest. If further measurements are required, the process proceeds to step 612; otherwise, the process concludes. In a use case involving a large commercial development, the system may be redeployed to adjacent boreholes to ensure comprehensive site characterization.

If additional deployment locations are identified, the process is repeated at the new sites at step 612. This involves redeploying the sensor groups and heater groups, allowing for thermal equilibrium, and performing the quantification steps outlined above. For example, in a phased construction project, the system may be used to characterize each new borehole as drilling progresses.

In one or more embodiments, at step 613, upon fully quantifying the current geographic area of interest, the system proceeds to search for another site to repeat the process. This approach facilitates thorough analysis of geothermal properties across multiple locations, thereby aiding large-scale geothermal energy projects. For instance, in a city-wide geothermal retrofit initiative, the system may be deployed sequentially at dozens of sites to build a comprehensive thermal property database for urban planning.

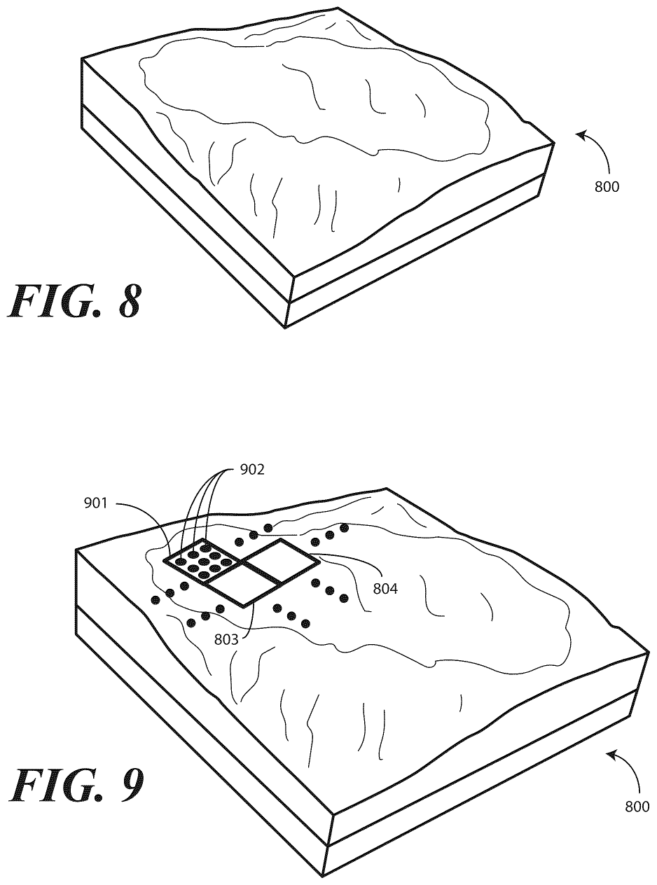

Turning now to FIG. 8, illustrated therein is a geographic site of interest 800. A geographical site of interest 800 that serves as the foundational context for deploying the system and methods described in the present disclosure. At the geographical site of interest 800, the terrain and subsurface environment are selected for the quantification of ground thermophysical properties, such as thermal conductivity and specific heat capacity. The site 800 may include a variety of surface features and subsurface layers, each representing different geological formations that can impact the performance and design of geothermal energy systems.

At the surface, the system user identifies and defines the measurement site based on geological, environmental, or geothermal characteristics. This selection process plays a role in ensuring that the subsequent deployment of borehole and associated instrumentation will yield reliable and representative data. For example, a user may select a site 800 in a residential area with anticipated subsurface heterogeneity to optimize the design of a borehole heat exchanger array, thereby reducing the risk of improper system sizing and minimizing the need for costly retrofits.

At the subsurface layers, the system is designed to accommodate a range of geological conditions, including soil, sediment, and bedrock. The presence of these layers demonstrates the system's adaptability and supports deployment between zero and three kilometers, inclusive, below a surface of the geographic area of interest in the borehole. The ability to deploy the inflatable sleeve, temperature sensors, and heating elements at various depths and in diverse materials provides users with the flexibility to conduct depth-resolved measurements in both shallow and deep geothermal projects.

Turning now to FIG. 9, an array 901 of gridded sections 803,804 have been made with boreholes 902 drilled. At each borehole 902, the system enables the insertion of an inflatable sleeve carrying an array of temperature sensors and heating elements.

The boreholes 902 can be positioned at the selected measurement site within the geographical site of interest 800 and serve as the conduit for deploying the encapsulated instrumentation. This arrangement allows for the direct measurement of the thermal response of the surrounding geological formation, rather than relying on indirect or averaged fluid temperature measurements. As a result, users benefit from improved accuracy in quantifying thermal conductivity and specific heat capacity, which directly supports the simultaneous determination of these properties.

A practical use case at the geographical site of interest 800 involves a user deploying the system in a new residential development. By selecting a representative site and deploying the inflatable sleeve and sensor array into the boreholes 902, the user can rapidly obtain depth-resolved thermal property data. This data enables the precise sizing of borehole heat exchangers, reducing the likelihood of over- or under-design and thereby lowering installation costs and improving long-term system efficiency. The streamlined deployment and retrieval process, facilitated by the flexible sleeve and modular system architecture, further reduces user effort and field time, enhancing convenience and accessibility for both small-scale and large-scale applications.

In summary, FIGS. 8-9 illustrate the hierarchical relationship between the geographical site of interest 800, the surface, the subsurface layers, and the boreholes 902. Each element plays a role in enabling the system to deliver reliable, depth-resolved quantification of ground thermophysical properties, supporting the claims and providing tangible benefits to users in terms of accuracy, efficiency, and operational convenience.

In this context, since the boreholes are situated at a measurement site within a geographic area of interest, depth markers can be employed to define the vertical extent of the boreholes, which can range from 0.05 to three kilometers below the surface. In one or more embodiments, a flexible sleeve is deployed into the boreholes to facilitate the measurement of subsurface thermal properties. A control unit is operable to define and manage the parameters of the measurement site, thereby ensuring proper alignment and positioning of the sensor array and the heating elements.

In some embodiments, the flexible sleeve encapsulates the temperature sensors and the heating elements in a co-registered arrangement to ensure accurate spatial correlation between the heat source and the measurement points. The sensor array comprises a vertically stacked plurality of temperature sensors connected via sensor wiring to sensor connection points. The heating elements, constructed from bundled nickel-chromium wire, are operatively coupled to a power supply. Additionally, insulation material is provided to minimize axial and convective heat losses, thereby directing the heat generated by the heating elements outward into the surrounding geological formation.

Accordingly, after deployment, the borehole is allowed to reach thermal equilibrium before activating the heating elements. The insulation material serves to minimize external disturbances, permitting the subsurface environment to stabilize. Depth markers continue to monitor the vertical positioning of the flexible sleeve during this equilibrium phase.

Thereafter, the heating elements are activated using the power supply to deliver a controlled heat distribution of known power for a predetermined amount of time. The activation duration and power level are predefined to ensure consistent thermal perturbations within the wall of the borehole. A heat flow analysis monitors the resulting thermal gradients generated by the heating elements, which are strategically positioned along the flexible sleeve.

In one or more embodiments, the temperature sensors record a time series of temperature measurements along the borehole length. Sensor data transmission ensures that the recorded temperature data is transmitted to the control unit for further analysis. As a result, the sensor array provides depth-resolved temperature data, which is necessary for quantifying subsurface thermal properties.

In some embodiments, a data processing unit receives the temperature data from the control unit and applies advanced numerical inversion methods to solve a mathematical model that includes thermal conductivity and specific heat capacity as unknown variables. The numerical inversion method interprets the temperature time-series data to quantify the thermal properties of the borehole.

Thus, thermal conductivity and specific heat capacity are quantified simultaneously as a function of depth within the borehole. The flexible sleeve ensures consistent positioning of the temperature sensors and heating elements, enabling precise measurement of the subsurface thermal properties.

In one or more embodiments, the system can optionally monitor the performance of borehole heat exchangers by analyzing thermal resistance and heat transfer efficiency. The control unit and the data processing unit facilitate real-time monitoring and long-term data collection.

Accordingly, the recorded temperature data and quantified thermal properties are used to generate geothermal heat flow maps and produce geologic models of the subsurface environment. Depth markers and sensor data transmission ensure accurate spatial correlation of the data.

In some embodiments, the control unit evaluates the collected data to determine whether additional quantification is required. If the data is insufficient or further analysis is needed, the system can be re-deployed to collect additional measurements.

If additional deployment locations are required within the geographic area of interest, the process is repeated by deploying the flexible sleeve, the sensor array, and the heating elements into a new borehole at the identified measurement site. A connection cable facilitates retrieval and re-deployment of the flexible sleeve.

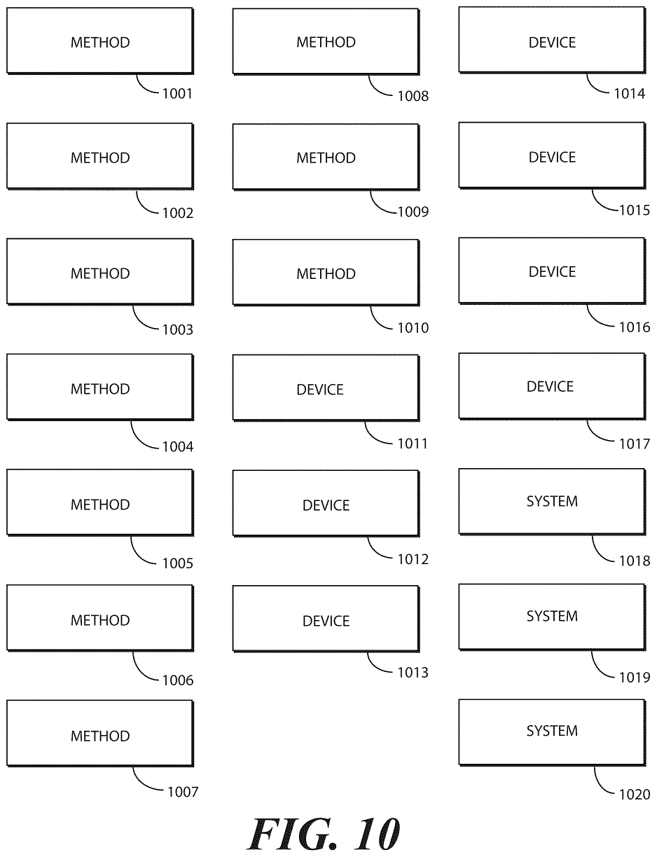

Turning now to FIG. 10, illustrated therein are various embodiments of the disclosure. The embodiments of FIG. 10 are shown as labeled boxes in FIG. 10 due to the fact that the individual components of these embodiments have been illustrated in detail in FIGS. 1-9, which precede FIG. 10. Accordingly, since these items have previously been illustrated and described, their repeated illustration is no longer essential for a proper understanding of these embodiments. Thus, the embodiments are shown as labeled boxes.

At 1001, a method for quantifying thermal properties of a borehole comprises deploying, into a borehole located at a measurement site of a geographic area of interest, an array of temperature sensors and an array of heating elements encapsulated in a sleeve, activating the array of heating elements to generate a resulting vertical heat distribution in the borehole, and measuring a vertical distribution time series of temperature measurements using the array of temperature sensors. At 1002, the method of 1001 further comprises deploying another array of temperature sensors into the borehole with the array of temperature sensors and the array of heating elements, wherein the vertical distribution time series of temperature measurements is measured using both the array of temperature sensors and the another array of temperature sensors.

At 1003, the method of 1002 further comprises quantifying a thermal conductivity and volumetric specific heat capacity for the borehole as a function of depth within the borehole using the vertical distribution time series of temperature measurements. At 1004, the thermal conductivity and the volumetric specific heat capacity of 1003 are quantified simultaneously for the borehole.

At 1005, the array of temperature sensors of 1001 comprises a vertically stacked plurality of temperature sensors. At 1005, the array of heating elements pf 1001 comprises a vertically stacked plurality of heating elements. At 1005, the deploying of 1001 comprises positioning both the vertically stacked plurality of temperature sensors and the vertically stacked plurality of heating elements between zero and three kilometers, inclusive, below a surface of the geographic area of interest in the borehole.

At 1006, the vertically stacked plurality of temperature sensors and the vertically stacked plurality of heating elements of 1005 are positioned at predetermined intervals within the borehole that generate temperature events at discrete intervals along a predefined depth of the borehole in response to activating the vertically stacked plurality of heating elements. At 1007, the activating the array of heating elements of 1001 comprises delivering a predetermined amount of power to the array of heating elements for a predefined amount of time. At 1008, the measuring the vertical distribution time series of temperature measurements of 1007 occurs after thermal perturbations within the borehole caused by the deploying have equalized.

At 1009, the method of 1001 further comprises quantifying a thermal conductivity and volumetric specific heat capacity for the borehole as a function of depth within the borehole by applying a numerical inversion method and solving a corresponding mathematical model that includes the thermal conductivity and the volumetric specific heat capacity as unknown variables. At 1010, the method of 1001 further comprises, after the deploying and before the activating, filling the borehole atop the array of temperature sensors and the array of heating elements, an insulating material.

At 1011, a device comprises a plurality of vertically stacked temperature sensors and at least one heater element carried by a borehole insertable device housing, a power source operable with the at least one heater element, and an interrogator operable with the plurality of vertically stacked temperature sensors. At 1011, the interrogator is configured to query each temperature sensor of the plurality of vertically stacked temperature sensors after the power source actuates the at least one heater element for a predefined duration to determine a vertical temperature distribution along the borehole insertable device housing.

At 1012, the borehole insertable device housing of 1011 comprises an inflatable sleeve. At 1013, the each temperature sensor of 1012 comprises a fiber optic sensor such that the plurality of temperature sensors defines a fiber Bragg grating.

At 1014, the at least one heater element of 1013 comprises a wire heating element. At 1015, the wire heating element of 1014 and the fiber optic sensor defining the fiber Bragg grating extend along a length of the inflatable sleeve parallel to a central axis of the flexible sleeve.

At 1016, the plurality of temperature sensors of 1013 comprises at least two columns with at least two temperature sensors in each column. At 1016, the at least two columns are arranged along lengths of the borehole insertable device housing at radially displaced locations from the at least one heating element. At 1017, the device of 1011 further comprises at least one other temperature sensor that is radially displaced from the at least one heater element on the borehole insertable device housing.

At 1018, a system for evaluating ground thermophysical properties, the system comprises an inflatable sleeve carrying a fiber optic sensor defining a fiber Bragg grating extending along a length of the inflatable sleeve parallel to a central axis of the inflatable sleeve and at least one heating element situated along the sleeve such that the at least one heating element is situated between at least some optical fiber sensors of the fiber Bragg grating and at least some other optical fiber sensors of the fiber Bragg grating. At 1018, the system comprises a power source operable with the at least one heater element and an interrogator operable with the fiber Bragg grating. At 1018, the interrogator is configured to query the fiber Bragg grating after the power source actuates the at least one heater element to determine a vertical temperature distribution along the length of the flexible sleeve.

At 1019, the system of 1018 further comprises a computing unit configured to receive temperature data from the interrogator and execute a numerical inversion method to determine thermal conductivity parameters and volumetric specific heat capacity parameters along the length of the inflatable sleeve when the inflatable sleeve is positioned against a subterranean geological formation. At 1020, the inflatable sleeve is manufactured from at least two sheets of polyethylene, the at least one heating element is manufactured from nickel-chromium wire, and the nickel-chromium wire and the fiber optic sensor are sandwiched between a pair of sheets of the at least two sheets of polyethylene and oriented parallel with a central axis of the inflatable sleeve.

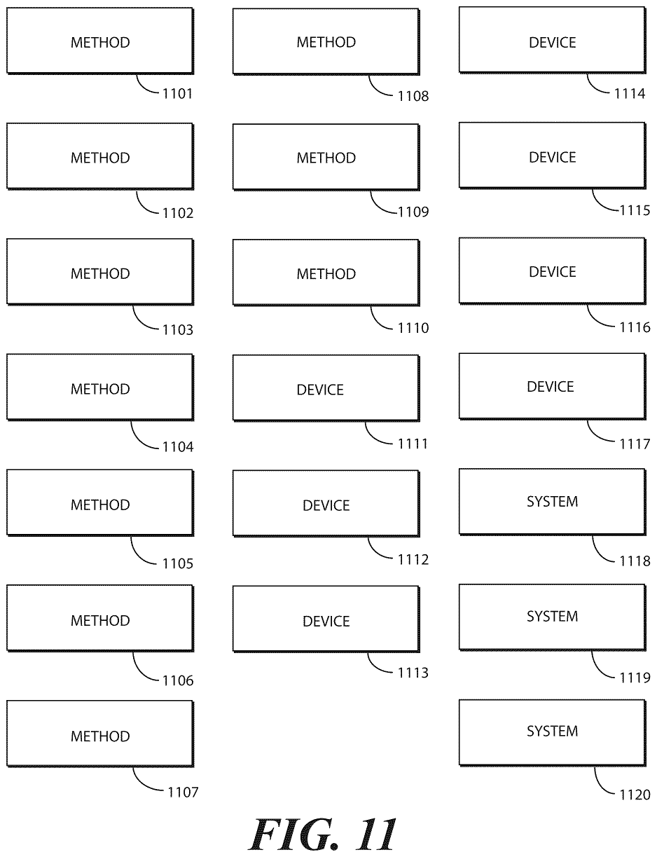

Turning now to FIG. 11, illustrated therein are various other embodiments of the disclosure. The embodiments of FIG. 11 are shown as labeled boxes in FIG. 11 due to the fact that the individual components of these embodiments have been illustrated in detail in FIGS. 1-9, which precede FIG. 11. Accordingly, since these items have previously been illustrated and described, their repeated illustration is no longer essential for a proper understanding of these embodiments. Thus, the embodiments are shown as labeled boxes.

At 1101, a method for quantifying thermal properties of a borehole comprises deploying, into a borehole located at a measurement site of a geographic area of interest, an array of temperature sensors and an array of heating elements encapsulated in a sleeve, activating the array of heating elements to generate a resulting heat distribution in the borehole, and measuring a time series of temperature measurements using the array of temperature sensors. At 1102, the method of 1101 further comprises deploying another array of temperature sensors into the borehole with the array of temperature sensors and the array of heating elements, wherein the time series of temperature measurements is measured using both the array of temperature sensors and the another array of temperature sensors.

At 1103, the method of 1102 further comprises quantifying a thermal conductivity and specific heat capacity for the borehole as a function of depth within the borehole using the time series of temperature measurements. At 1104, the thermal conductivity and the specific heat capacity of 1103 are quantified simultaneously for the borehole.

At 1105, the array of temperature sensors of 1101 comprises a vertically stacked plurality of temperature sensors. At 1105, the array of heating elements of 1101 comprises a vertically stacked plurality of heating elements. At 1105, the deploying of 1101 comprises positioning both the vertically stacked plurality of temperature sensors and the vertically stacked plurality of heating elements between zero and three kilometers, inclusive, below a surface of the geographic area of interest in the borehole.

At 1106, the vertically stacked plurality of temperature sensors and the vertically stacked plurality of heating elements of 1105 are positioned at predetermined intervals within the borehole that generate temperature events at discrete intervals along a predefined depth of the borehole in response to activating the vertically stacked plurality of heating elements. At 1107, the activating the array of heating elements of 1101 comprises delivering a predetermined amount of power to the array of heating elements for a predefined amount of time. At 1008, the measuring the time series of temperature measurements of 1107 occurs after thermal perturbations within the borehole caused by the deploying have equalized.

At 1109, the method of 1101 further comprises quantifying a thermal conductivity and specific heat capacity for the borehole as a function of depth within the borehole by applying a numerical inversion method and solving a corresponding mathematical model that includes the thermal conductivity and the specific heat capacity as unknown variables. At 1110, the method of 1101 further comprises, after the deploying and before the activating, filling the borehole atop the array of temperature sensors and the array of heating elements, an insulating material.

At 1111, a device comprises a plurality of vertically stacked temperature sensors and at least one heater element carried by a borehole insertable device housing, a power source operable with the at least one heater element, and an interrogator operable with the plurality of vertically stacked temperature sensors. At 1111, the interrogator is configured to query each temperature sensor of the plurality of vertically stacked temperature sensors after the power source actuates the at least one heater element for a predefined duration to determine a temperature distribution along the borehole insertable device housing.

At 1112, the borehole insertable device housing of 1111 comprises an inflatable sleeve. At 1113, the each temperature sensor of 1112 comprises a fiber optic sensor such that the plurality of temperature sensors defines a fiber Bragg grating.

At 1114, the at least one heater element of 1113 comprises a wire heating element. At 1115, the wire heating element of 1114 and the fiber optic sensor defining the fiber Bragg grating extend along a length of the inflatable sleeve parallel to a central axis of the flexible sleeve.

At 1116, the plurality of temperature sensors of 1113 comprises at least two columns with at least two temperature sensors in each column. At 1116, the at least two columns are arranged along lengths of the borehole insertable device housing at radially displaced locations from the at least one heating element. At 1117, the device of 1111 further comprises at least one other temperature sensor that is radially displaced from the at least one heater element on the borehole insertable device housing.

At 1118, a system for evaluating ground thermophysical properties, the system comprises an inflatable sleeve carrying a fiber optic sensor defining a fiber Bragg grating extending along a length of the inflatable sleeve parallel to a central axis of the inflatable sleeve and at least one heating element situated along the sleeve such that the at least one heating element is situated between at least some optical fiber sensors of the fiber Bragg grating and at least some other optical fiber sensors of the fiber Bragg grating. At 1118, the system comprises a power source operable with the at least one heater element and an interrogator operable with the fiber Bragg grating. At 1118, the interrogator is configured to query the fiber Bragg grating after the power source actuates the at least one heater element to determine a temperature distribution along the length of the flexible sleeve.

At 1119, the system of 1118 further comprises a computing unit configured to receive temperature data from the interrogator and execute a numerical inversion method to determine thermal conductivity parameters and specific heat capacity parameters along the length of the inflatable sleeve when the inflatable sleeve is positioned against a subterranean geological formation. At 1120, the inflatable sleeve is manufactured from at least two sheets of polyethylene, the at least one heating element is manufactured from nickel-chromium wire, and the nickel-chromium wire and the fiber optic sensor are sandwiched between a pair of sheets of the at least two sheets of polyethylene and oriented parallel with a central axis of the inflatable sleeve.

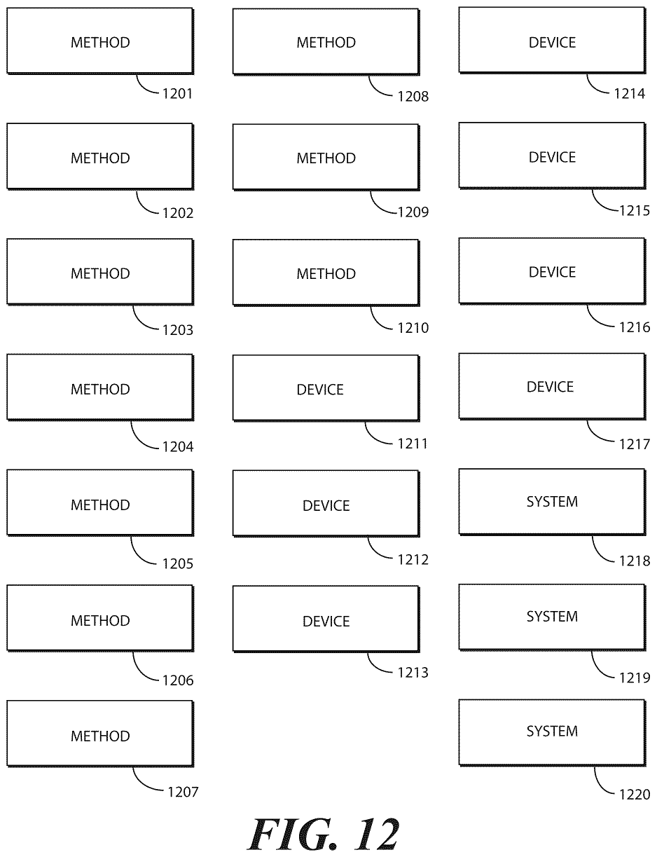

Turning now to FIG. 12, illustrated therein are various embodiments of the disclosure. The embodiments of FIG. 12 are shown as labeled boxes in FIG. 12 due to the fact that the individual components of these embodiments have been illustrated in detail in FIGS. 1-9, which precede FIG. 12. Accordingly, since these items have previously been illustrated and described, their repeated illustration is no longer essential for a proper understanding of these embodiments. Thus, the embodiments are shown as labeled boxes.

At 1201, a method for quantifying thermal properties of geologic formations comprises deploying, into a borehole located at a measurement site of a geographic area of interest, an array of temperature sensors and an array of heating elements encapsulated in a sleeve, activating the array of heating elements to generate a resulting temperature distribution in the borehole and sidewall, and measuring a time series of the temperature distribution using the array of temperature sensors. At 1202, the method of 1201 further comprises deploying another array of temperature sensors and another array of heating elements into the borehole with the array of temperature sensors and the array of heating elements, wherein heat is applied by the array of heating elements and the another array of heating elements and the time series of temperature measurements is measured using both the array of temperature sensors and the another array of temperature sensors.

At 1203, the method of 1202 further comprises quantifying a thermal conductivity and specific heat capacity for the geologic material as a function of depth or distance along the borehole using the time series of temperature measurements. At 1204, the thermal conductivity and the specific heat capacity of 1203 are quantified simultaneously for the geologic formations adjacent to the borehole.

At 1205, the array of temperature sensors of 1201 comprises a plurality of temperature sensors arranged along the axis and along the circumference of a cylindrical sleeve. At 1205, the array of heating elements comprises a plurality of heating elements arranged along the axis of a cylindrical sleeve. At 1205, the deploying comprises positioning both the plurality of temperature sensors and the plurality of heating elements along the wall of a cylindrical borehole between zero and three kilometers, inclusive, below a surface of the geographic area of interest in the borehole.

At 1206, the plurality of temperature sensors and the plurality of heating elements of 1205 are positioned at predetermined locations and intervals along the sleeve such that heating events are generated at discrete locations and intervals at predefined distances along the borehole in response to activating the plurality of heating elements. At 1207, the activating the array of one or more heating elements of 1201 comprises delivering a predetermined amount of thermal power to the array of one or more heating elements for a predefined duration. At 1208, the measuring the time series of temperature measurements of 1207 occurs after thermal perturbations within the borehole and sidewall caused by the deploying have equilibrated.

At 1209, the method of 1201 further comprises quantifying a thermal conductivity and specific heat capacity for the geologic formations adjacent to or in the vicinity of the borehole by applying a numerical inversion method and solving a corresponding mathematical model that includes the thermal conductivity and the specific heat capacity as unknown variables. At 1210, the method of 1201 further comprises, after the deploying and before the activating, filling the borehole atop or around the array of temperature sensors and the array of heating elements, an insulating material.

At 1211, a device comprises a plurality of vertically stacked temperature sensors and at least one heater element carried by a borehole insertable device housing. At 1211, the device comprises a power source operable with the at least one heater element and an interrogator operable with the plurality of vertically stacked temperature sensors. At 1211, the interrogator is configured to query each temperature sensor of the plurality of vertically stacked temperature sensors after the power source actuates the at least one heater element for a predefined duration to determine a temperature distribution along the length of or circumferentially around the borehole insertable device housing.

At 1212, the borehole insertable device housing of 1211 comprises an inflatable sleeve. At 1213, each temperature sensor of 1212 comprises a fiber optic sensor such that the plurality of vertically stacked temperature sensors defines a fiber Bragg grating. At 1214, the at least one heater element of 1213 comprises a wire heating element.

At 1215, the wire heating element of 1214 and the fiber optic sensor defining the fiber Bragg grating extend along a length of the inflatable sleeve parallel to a central axis of the inflatable sleeve. At 1216, the plurality of vertically stacked temperature sensors of 1213 comprises at least two columns with at least two temperature sensors in each column. At 1216, the at least two columns are arranged along lengths of the borehole insertable device housing at circumferentially displaced locations from the at least one heating element. At 1217, the device of 1211 further comprises at least one other temperature sensor that is circumferentially displaced from the at least one heater element on the borehole insertable device housing.

At 1218, a system for evaluating ground thermophysical properties comprises an inflatable sleeve carrying a fiber optic sensor defining a fiber Bragg grating extending along a length of the inflatable sleeve parallel to a central axis of the inflatable sleeve. At 1218, the system comprises at least one heating element situated along the inflatable sleeve such that the at least one heating element is situated axially or circumferentially between at least some optical fiber sensors of the fiber Bragg grating and at least some other optical fiber sensors of the fiber Bragg grating.

At 1218, the system comprises a power source operable with the at least one heating element and an interrogator operable with the fiber Bragg grating. At 1218, the interrogator is configured to query the fiber Bragg grating after the power source actuates the at least one heating element to determine a temperature distribution along the length of or circumferentially around the inflatable sleeve.

At 1219, the system of 1218 further comprises a computing unit configured to receive temperature data from the interrogator and execute a numerical inversion method to determine thermal conductivity parameters and specific heat capacity parameters of the geologic formation along the length of the inflatable sleeve when the inflatable sleeve is positioned against a subterranean geological formation. At 1220, the inflatable sleeve of 1218 is manufactured from at least two sheets of polyethylene, the at least one heating element is manufactured from nickel-chromium wire, and the nickel-chromium wire and the fiber optic sensor are sandwiched between a pair of sheets of the at least two sheets of polyethylene and oriented parallel with a central axis of the inflatable sleeve.

Before describing in detail even more embodiments that are in accordance with the present disclosure, it should be observed that the embodiments reside primarily in combinations of method steps and apparatus components related to deploying, into a borehole located at a measurement site of the geologic formation, an array of temperature sensors and an array of heating elements encapsulated in a sleeve, activating the array of heating elements to generate a resulting temperature distribution at a sidewall of the borehole, and measuring a time series of measurements of the resulting temperature distribution using the array of temperature sensors. Any process descriptions or blocks in flow charts should be understood as representing modules, segments, or portions of code which include one or more executable instructions for implementing specific logical functions or steps in the process.

It will be appreciated that embodiments of the disclosure described herein may be comprised of one or more conventional processors and unique stored program instructions that control the one or more processors to implement, in conjunction with certain non-processor circuits, some, most, or all of the functions of query each temperature sensor of a plurality of temperature sensors of a device comprising the plurality of temperature sensors and at least one heater element carried by a borehole insertable device housing, a power source operable with the at least one heater element, and an interrogator operable with the plurality of temperature sensors after the power source actuates the at least one heater element for a predefined duration to determine a temperature distribution along a length of, and around a circumference of, the borehole insertable device housing as described herein. The non-processor circuits may include, but are not limited to, a radio receiver, a radio transmitter, signal drivers, clock circuits, power source circuits, and user input devices.

As such, these functions may be interpreted as steps of a method to perform querying a fiber Bragg grating of a device comprising an inflatable sleeve carrying a fiber optic sensor defining the fiber Bragg grating extending along a length of the inflatable sleeve parallel to a central axis of the inflatable sleeve, at least one heating element situated along the inflatable sleeve such that the at least one heating element is situated between at least some optical fiber sensors of the fiber Bragg grating and at least some other optical fiber sensors of the fiber Bragg grating, a power source operable with the at least one heating element, and an interrogator operable with the fiber Bragg grating after the power source actuates the at least one heating element to determine a temperature distribution along the length of, and around a circumference of, the inflatable sleeve.

Embodiments of the disclosure contemplate that the accurate characterization of subsurface thermal properties, specifically thermal conductivity and specific heat capacity, is essential for the effective design and operation of geothermal heat pump (GHP) systems. These properties influence heat transfer rates and energy storage capacity, directly affecting the performance and cost-efficiency of borehole heat exchangers (BHEs).

Conventional methods, such as thermal response tests (TRTs), rely on measuring fluid temperature within completed BHEs over extended durations, typically 48 to 100 hours. These methods often assume uniform temperature profiles and purely conductive heat transfer, leading to notable inaccuracies in estimating thermal conductivity while neglecting specific heat capacity.

Furthermore, TRTs require dedicated boreholes and completed BHE installations, making them prohibitively expensive for small-scale projects and impractical for depth-resolved measurements. Errors in thermal property estimation can result in oversized systems with inflated costs or undersized systems that underperform, necessitating costly retrofits. These limitations have restricted the broader adoption of GHP systems, particularly in residential and light commercial applications.

Advantageously, embodiments of the present disclosure address these challenges by introducing a novel method and apparatus for quantifying subsurface thermal properties with high precision, reduced cost, and improved depth resolution. In one or more embodiments, the described solution employs a deployable borehole package comprising a flexible sleeve encapsulating an array of temperature sensors and heating elements. In one or more embodiments, the sleeve, which can be fabricated from materials such as polyethylene or Tyvek.sup.TM, is inserted into a borehole, inflated, and filled with insulating material to facilitate precise thermal measurements.

In one or more embodiments, by activating the heating elements and measuring the temperature response at multiple depths and circumferential positions, the system enables depth-specific characterization of ground thermophysical properties. High-precision fiber Bragg gratings (FBGs) or alternative sensors capture transient temperature data, which is analyzed using advanced numerical inversion methods to simultaneously determine thermal conductivity and specific heat capacity.

Advantageously, this approach eliminates the need for completed BHEs, significantly reduces testing time, and provides reliable, cost-effective measurements applicable to various geologic formations and borehole configurations. Additionally, the system's modular design allows for redeployment, further enhancing its economic feasibility and scalability. By overcoming the limitations of conventional TRTs, the described method facilitates optimized GHP system design, paving the way for broader adoption of geothermal technologies.

As will be described below, the disclosed system and method pertain to an advanced approach for quantifying subsurface thermal properties, specifically thermal conductivity (k_{T}) and specific heat capacity (cₚ), to enhance the design and performance of geothermal heat pump systems. The system includes a deployable borehole package comprising a flexible sleeve encapsulating an array of temperature sensors and heating elements.

The sleeve, fabricated from materials such as polyethylene or Tyvek.sup.TM, is inserted into a borehole, inflated, and filled with insulating material to facilitate precise thermal measurements. By activating the heating elements and measuring the temperature response at multiple depths and circumferential positions, the method enables depth-resolved characterization of ground thermophysical properties.

High-precision fiber Bragg gratings (FBGs) or alternative sensors are utilized to capture transient temperature data, which is analyzed using advanced numerical inversion methods to determine k_{T} and cₚ. This approach eliminates the need for completed borehole heat exchangers, reduces testing time, and provides reliable, cost-effective measurements applicable to various geologic formations and borehole configurations.

In one or more embodiments, a method provides an innovative approach for quantifying thermal properties of a geologic formation by utilizing a deployable borehole package. In one or more embodiments, this package comprises an array of temperature sensors and heating elements encapsulated within a flexible sleeve.

Upon deployment into a borehole at the measurement site, the heating elements are activated to generate a controlled temperature distribution along the borehole sidewall. The temperature sensors then measure a time series of temperature data resulting from the heat transfer interactions between the heating elements and the surrounding geologic material. This measured data enables precise characterization of the thermal conductivity and specific heat capacity of the subsurface, facilitating improved design and optimization of geothermal heat pump systems.

Deploying an array of temperature sensors and heating elements encapsulated in a sleeve into a borehole enables precise placement of measurement and heating components directly against the borehole sidewall. This arrangement ensures direct thermal interaction with the geologic formation, minimizing interference from external factors such as fluid dynamics within the borehole. Activating the heating elements generates a controlled temperature distribution along the borehole sidewall, which propagates into the surrounding geologic material. This controlled heating allows for localized thermal perturbations that are necessary for evaluating the thermal properties of the formation.

Measuring the time series of temperature data using the array of temperature sensors provides high-resolution spatial and temporal information about the thermal response of the geologic material. This data can be used to analyze heat transfer dynamics, enabling the determination of thermal conductivity and specific heat capacity with improved accuracy. The use of a sleeve encapsulating the sensors and heating elements ensures consistent contact with the borehole sidewall, reducing measurement errors and enhancing the reliability of the thermal property quantification process.

In one or more embodiments, a device described comprises a borehole-insertable housing that integrates a plurality of temperature sensors and at least one heater element, enabling precise thermal measurements within subsurface geologic formations. The temperature sensors are operatively coupled to an interrogator, which is configured to query each sensor after the heater element is actuated by a power source for a predefined duration.

Advantageously, this configuration allows for the determination of a temperature distribution along the length and circumference of the housing, facilitating the characterization of thermal conductivity and specific heat capacity of the surrounding geologic material. The integration of the heater element and temperature sensors within the housing ensures direct thermal interaction with the borehole sidewall, minimizing external interference and enhancing measurement accuracy.

The device integrates a plurality of temperature sensors and at least one heater element within a borehole-insertable housing, enabling precise thermal measurements directly at the borehole sidewall. This arrangement ensures direct thermal interaction with the geologic formation, minimizing interference from external factors such as fluid dynamics within the borehole.

The inclusion of a power source operable with the heater element allows controlled delivery of thermal energy, while the interrogator queries the temperature sensors to capture spatial and temporal temperature distributions. This configuration facilitates the determination of thermal conductivity and specific heat capacity parameters of the surrounding geologic material with improved accuracy and resolution.

By embedding the temperature sensors and heater element within the housing, the device eliminates the need for external measurement setups, reducing complexity and enhancing portability. The predefined duration of heater actuation ensures consistent thermal perturbations, which are necessary for reliable data acquisition. Furthermore, the device's ability to measure temperature distributions along both the length and circumference of the housing provides comprehensive thermal profiling, supporting depth-resolved and circumferentially resolved characterization of subsurface thermal properties.

In one or more embodiments, a system provides a novel approach for evaluating ground thermophysical properties by employing an inflatable sleeve integrated with advanced sensing and heating components. In one or more embodiments, the inflatable sleeve incorporates a fiber optic sensor designed as a fiber Bragg grating (FBG), which extends along the length of the sleeve parallel to the central axis of the sleeve. Furthermore, at least one heating element is strategically positioned along the sleeve, located between specific optical fiber sensors of the FBG array to enable precise thermal interaction.

In one or more embodiments, the system includes a power source operable with the heating element and an interrogator configured to query the FBG after the heating element is activated. This arrangement facilitates the determination of temperature distributions along the length and circumference of the sleeve, supporting accurate characterization of thermal conductivity and specific heat capacity of the surrounding geologic material. The modular design of the sleeve allows for deployment in various borehole configurations, ensuring adaptability to diverse subsurface conditions while maintaining high-resolution measurements necessary for geothermal system optimization.

Other advantages will be described below. Still others will be obvious to those of ordinary skill in the art having the benefit of this disclosure.

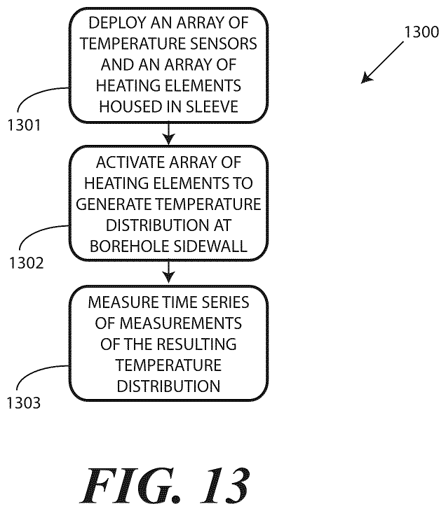

Turning now to FIG. 13, illustrated therein is one explanatory method 1300 in accordance with one or more embodiments of the disclosure. In one or more embodiments, the method 1300 illustrated in FIG. 13 provides a novel approach for quantifying thermal properties of a geologic formation, specifically thermal conductivity and specific heat capacity, with high precision and depth resolution. Accordingly, the method 1300 comprises three sequential steps: deploying an array of temperature sensors and heating elements encapsulated in a sleeve into a borehole at step 1301, activating the array of heating elements to generate a controlled temperature distribution at the borehole sidewall at step 1302, and measuring a time series of temperature data resulting from the heat transfer interactions using the array of temperature sensors at step 1303. Each of these steps is described in detail below.

In one or more embodiments, step 1301 involves deploying an array of temperature sensors and heating elements encapsulated in a sleeve into a borehole located at a measurement site of the geologic formation. In one or more embodiments, the sleeve is configured to carry the array of temperature sensors and heating elements, ensuring precise placement of these components against the borehole sidewall.

For example, the sleeve can be fabricated from materials such as polyethylene or Tyvek.sup.TM, which offer flexibility, durability, and resistance to environmental degradation. In some embodiments, the deployment process begins by rolling the sleeve onto a spool to facilitate transportation and handling and thereafter unrolling and inserting the sleeve into the borehole using a drop weight or other suitable deployment mechanism.

In one or more embodiments, the array of temperature sensors comprises a plurality of temperature sensors, including a first set of sensors extending along the sleeve substantially parallel to a central axis of the sleeve and a second set of sensors extending around the circumference of the sleeve. This configuration facilitates measurement of temperature distributions both along the length and around the circumference of the borehole.

In addition, in one or more embodiments the array of heating elements and comprises a plurality of heating elements extending along the sleeve substantially parallel to the central axis. In one or more embodiments, these heating elements and are strategically positioned to provide uniform and controlled delivery of thermal energy to the geologic formation.

In some embodiments, the deployment process further includes positioning the sleeve and the encapsulated components at depths within the borehole ranging from zero to three kilometers, inclusive, below the surface of the geologic formation. This depth range enables application of the method 1300 to various geologic formations, from shallow soil layers to deep bedrock. For example, in one use case, the method 1300 can be utilized in residential settings to characterize subsurface thermal properties for small-scale geothermal heat pump systems. In another use case, the method 1300 can be implemented in commercial or industrial projects requiring detailed thermal property measurements at greater depths.

In one or more embodiments, step 1302 involves activating the array of heating elements to generate a controlled temperature distribution at the borehole sidewall. The heating elements are actuated by a power source operable with the array, delivering a predefined amount of thermal energy to the sidewall for a predefined duration.

Accordingly, this controlled heating process creates localized thermal perturbations necessary for evaluating the thermal properties of the geologic formation. The heating events occur at discrete locations along the borehole corresponding to the predetermined positions and intervals of the heating elements along the sleeve.

In some embodiments, the activation process is configured to ensure that the thermal energy is applied uniformly and consistently, thereby minimizing external interference and enhancing measurement reliability. For example, the heating elements can be activated sequentially to create a temperature gradient along the borehole, enabling depth-resolved characterization of thermal conductivity and specific heat capacity. Alternatively, the heating elements can be activated simultaneously to generate a circumferential temperature distribution, allowing evaluation of anisotropic thermal properties in heterogeneous geologic formations.

In one or more embodiments, the heating elements can be fabricated from materials such as nickel-chromium wire, which offers high thermal efficiency and durability. In one or more embodiments, the wire heating elements are positioned along the sleeve such that they are situated between specific temperature sensors, ensuring direct thermal interaction with the geologic formation. As a result, the temperature sensors capture the transient temperature data arising from the heat transfer interactions with high spatial and temporal resolution.

In one or more embodiments, step 1303 involves measuring a time series of temperature data using the array of temperature sensors encapsulated in the sleeve. The temperature sensors are operatively coupled to an interrogator, which is configured to query each sensor after the heating elements have been activated. In one or more embodiments, the interrogator captures spatial and temporal temperature distributions along both the length and circumference of the sleeve, providing comprehensive thermal profiling of the geologic formation.

Accordingly, the measured temperature data enables precise characterization of the thermal conductivity and specific heat capacity of the geologic material. For example, the temperature response at points near the heating elements provides information on the rate of heat transfer, indicative of thermal conductivity, whereas the timing of temperature change at points farther away conveys information on heat storage capacity, indicative of specific heat capacity.

In one or more embodiments, advanced numerical inversion methods are applied to the time series of temperature data to simultaneously quantify thermal conductivity and specific heat capacity for portions of the geologic formation situated adjacent to the borehole. In some embodiments, the method 1300 can be applied to characterize subsurface thermal properties in sandy soil layers, which are commonly encountered in residential geothermal projects.

In another use case, the method 1300 can be used to evaluate thermal properties in fractured bedrock formations, which are relevant for large-scale geothermal energy systems. Additionally, the method 1300 can be adapted to include insulating material in the borehole atop or around the sleeve, further minimizing heat loss to the surrounding environment and enhancing measurement accuracy.

Thus, the ability to measure temperature distributions along both the length and circumference of the sleeve provides depth-resolved and circumferentially resolved characterization of subsurface thermal properties. This feature is particularly advantageous for applications requiring high-resolution thermal profiling, such as optimizing the design and performance of borehole heat exchangers in geothermal heat pump systems.

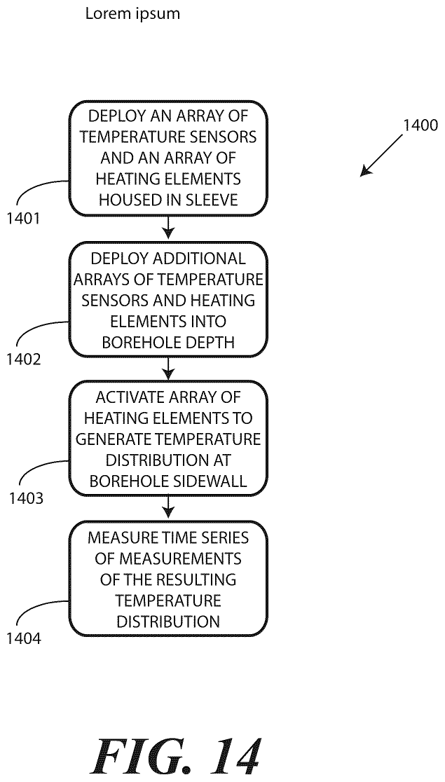

Turning now to FIG. 14, illustrated therein is another explanatory method 1400 in accordance with one or more embodiments of the disclosure. Since precise subsurface thermal characterization is necessary for efficient geothermal applications, the method 1400, as illustrated in FIG. 14, provides a systematic approach for quantifying the thermal properties of a geologic formation, specifically thermal conductivity and specific heat capacity, with high precision and depth resolution.

In one or more embodiments, the method comprises four sequential steps: deploying an array of temperature sensors and heating elements encapsulated in a sleeve at step 1401, deploying additional arrays of temperature sensors and heating elements into the borehole depth at step 1402, activating the array of heating elements to generate a controlled temperature distribution at the borehole sidewall at step 1403, and measuring a time series of the resulting temperature distribution using the array of temperature sensors at step 1404. Accordingly, each step is described in detail below.

In one or more embodiments, step 1401 begins with deploying an array of temperature sensors and an array of heating elements housed in a flexible sleeve into a borehole at a measurement site of the geologic formation. The sleeve is configured to carry the array of temperature sensors and heating elements, thereby ensuring precise placement of these components against the borehole sidewall.

The sleeve, which can be fabricated from materials such as polyethylene or Tyvek.sup.TM, is rolled onto a spool for ease of transportation and handling. In some embodiments, the sleeve is unrolled and inserted into the borehole using a drop weight or other suitable deployment mechanism. The flexibility of the sleeve allows the sleeve to conform to the borehole geometry, ensuring consistent contact with the borehole sidewall and minimizing interference from external factors, such as fluid dynamics within the borehole, while ensuring direct thermal interaction with the geologic formation.

The array of temperature sensors comprises a first set of sensors extending substantially parallel to a central axis of the sleeve and a second set of sensors extending around the circumference of the sleeve. Furthermore, the array of heating elements, which may include nickel-chromium wire or other suitable materials, is strategically positioned along the sleeve to provide uniform and controlled delivery of thermal energy to the geologic formation.

In one or more embodiments, step 1402 involves deploying additional arrays of temperature sensors and heating elements into the borehole to achieve depth-resolved measurements. In one or more embodiments, the additional arrays are positioned at predetermined depths within the borehole, ranging from shallow soil layers to deep bedrock, with depths extending up to three kilometers below the surface. This depth range enables the method to be applied to various geologic formations, from residential settings to large-scale commercial or industrial projects.

For example, in a residential setting, the method can be used to characterize subsurface thermal properties for small-scale geothermal heat pump systems. On the other hand, in a commercial or industrial project, the method can provide detailed thermal property measurements at greater depths, supporting the design and optimization of large-scale geothermal energy systems. The deployment of multiple arrays allows for the simultaneous collection of temperature data at various depths, significantly reducing the time required for testing compared to conventional thermal response tests (TRTs), while offering high-resolution thermal profiling for optimizing borehole heat exchanger design.

In one or more embodiments, step 1403 is performed by activating the array of heating elements to generate a controlled temperature distribution at the borehole sidewall. In one or more embodiments, the heating elements are actuated by a power source operable with the array, delivering a predefined amount of thermal energy to the sidewall for a predefined duration.

As a result, this controlled heating process creates localized thermal perturbations required for evaluating the thermal properties of the geologic formation. The heating events occur at discrete locations along the borehole, corresponding to the predetermined positions and intervals of the heating elements along the sleeve. In this manner, the activation process is configured to ensure that the thermal energy is applied uniformly and consistently, thereby minimizing external interference and enhancing measurement reliability. For example, the heating elements can be activated sequentially to create a temperature gradient along the borehole, enabling depth-resolved characterization of thermal conductivity and specific heat capacity, or simultaneously to generate a circumferential temperature distribution for evaluating anisotropic thermal properties in heterogeneous geologic formations.

In one or more embodiments, step 1404 comprises measuring a time series of temperature data using the array of temperature sensors encapsulated in the sleeve. The temperature sensors are operatively coupled to an interrogator, which is configured to query each sensor after the heating elements have been activated.

In one or more embodiments, the interrogator captures spatial and temporal temperature distributions along both the length and circumference of the sleeve, thereby providing comprehensive thermal profiling of the geologic formation. The measured temperature data enables precise characterization of thermal conductivity and specific heat capacity of the geologic material.

For example, the temperature response at points near the heating elements provides information on the rate of heat transfer, indicative of thermal conductivity, whereas the timing of temperature change at points farther away conveys information on heat storage capacity, indicative of specific heat capacity. Advanced numerical inversion methods are then applied to the time series of temperature data to simultaneously quantify thermal conductivity and specific heat capacity for portions of the geologic formation adjacent to the borehole. This approach eliminates the need for completed borehole heat exchangers, reduces testing time, and provides reliable, cost-effective measurements applicable to various geologic formations and borehole configurations.

The illustrative use case examples include: Residential Geothermal Heat Pump Systems, where, in a suburban setting, the method can be used to characterize the thermal properties of shallow soil layers to optimize the design of small-scale geothermal heat pump systems by deploying the sleeve to depths of up to thirty meters; Commercial and Industrial Projects, where the method can be applied to characterize thermal properties in fractured bedrock formations at depths up to three kilometers, supporting the design and optimization of large-scale geothermal energy systems; Research Applications, where academic and industrial researchers can employ the method to study the thermal behavior of various geologic formations-such as sandy soil layers, clay formations, or granite bedrock-thereby contributing to more accurate models for geothermal energy systems; and Monitoring of Borehole Heat Exchangers, where the method can be adapted to include a borehole heat exchanger (BHE) within the instrumented sleeve, followed by filling the borehole with thermal grout to enable detailed temperature measurements to evaluate the performance and thermal resistance of the BHE over its expected lifetime. By enabling precise, depth-resolved, and cost-effective characterization of subsurface thermal properties, the method 1400 of FIG. 14 addresses the limitations of conventional TRTs and supports the broader adoption of geothermal heat pump systems.

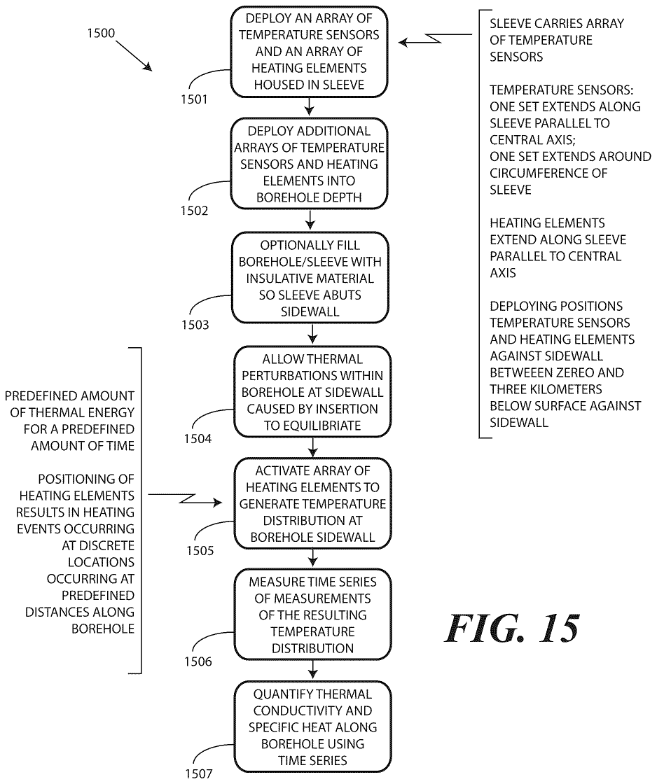

Turning now to FIG. 15, illustrated therein is yet another method 1500 in accordance with one or more embodiments of the disclosure. Since the method 1500 illustrated in FIG. 15 provides a novel approach for quantifying thermal properties of a geologic formation with high precision and depth resolution, each step of the method 1500 is performed in sequence to determine thermal conductivity and specific heat capacity.

The method 1500 comprises: deploying an array of temperature sensors and heating elements encapsulated in a sleeve into a borehole at step 1501; deploying another array of temperature sensors and heating elements encapsulated in a sleeve into a borehole at step 1502; placing an insulating material in the borehole atop or around the array of temperature sensors and heating elements at step 1503; waiting for thermal equilibrium to occur at step 1504; activating the array of heating elements to generate a controlled temperature distribution at the borehole sidewall at step 1505; measuring a time series of temperature data resulting from the heat transfer interactions using the array of temperature sensors at step 1506; quantifying thermal conductivity and specific heat capacity for geologic material of the geologic formation as a function of one or more of a depth within, or a distance along, the borehole at step 1507, which can include applying a numerical inversion method and solving a corresponding mathematical model that includes the thermal conductivity and the specific heat capacity as unknown variables. Each of these steps is described in detail below.

In one or more embodiments, step 1501 involves deploying, into a borehole located at a measurement site of the geologic formation, an array of temperature sensors and an array of heating elements encapsulated in a sleeve. In one or more embodiments, the sleeve carries the array of temperature sensors and the array of heating elements, thereby facilitating placement of the temperature sensors and the heating elements at, or proximate to, a sidewall of the borehole.

In some embodiments, the sleeve is fabricated from a flexible polymeric material, such as polyethylene or Tyvek.sup.TM, and is provided in a rolled configuration on a spool for transport to the measurement site. In one non-limiting example, deploying comprises lowering a distal portion of the sleeve into the borehole using a drop weight, unrolling the sleeve as it is advanced downward, and positioning the sleeve such that the temperature sensors and heating elements are situated at predetermined depths within the borehole.

In some embodiments, the temperature sensors include fiber optic sensors defining fiber Bragg gratings, thermistors, platinum resistance thermometers, or combinations thereof. In some embodiments, the heating elements include resistive heating elements, such as nickel-chromium wire heating elements, arranged to create repeatable heating events at discrete locations along the borehole.

In one or more embodiments, step 1502 involves deploying another array of temperature sensors and heating elements encapsulated in a sleeve into a borehole, wherein the deploying at step 1502 is performed in addition to, and in cooperation with, the deploying at step 1501 to provide increased spatial coverage and improved depth resolution. In one or more embodiments, the deploying at step 1502 includes deploying another sleeve carrying another array of temperature sensors and another array of heating elements, such that temperature measurements are obtained at multiple depths simultaneously without requiring completion of a borehole heat exchanger.

In some embodiments, the sleeve deployed at step 1502 is positioned at a second set of predetermined depths that are offset from, interleaved with, or otherwise complementary to the predetermined depths of the sleeve deployed at step 1501, thereby improving the ability to characterize thermal properties as a function of depth. In some embodiments, the sleeve deployed at step 1502 is deployed in the same borehole as the sleeve deployed at step 1501, including by lowering the sleeve deployed at step 1502 adjacent to the sleeve deployed at step 1501, by coupling sleeves end-to-end, by deploying sleeves on opposite sides of a central axis of the borehole, or by deploying sleeves having different lengths so that a larger depth interval is instrumented.

In one or more embodiments, step 1503 involves placing an insulating material in the borehole atop or around the array of temperature sensors and heating elements. In one or more embodiments, the insulating material is selected to reduce heat transfer within the borehole interior relative to heat transfer into the geologic formation, thereby biasing heat flow radially outward through the borehole sidewall and improving interpretability of the measured temperature response.

In some embodiments, placing the insulating material includes filling an interior of the sleeve with the insulating material after the sleeve is positioned in the borehole. In one non-limiting example, the insulating material comprises expanded perlite, dry sand, foam beads, aerogel particles, a low-conductivity lattice structure, or combinations thereof. In some embodiments, the insulating material is emplaced by gravity filling, by pumping, by pneumatic conveyance, or by other suitable emplacement techniques that permit the insulating material to occupy void space and promote consistent contact between the sleeve and the borehole sidewall.

In one or more embodiments, step 1504 involves waiting for thermal equilibrium to occur. In one or more embodiments, waiting includes allowing thermal perturbations introduced by the deploying steps, including frictional heating, fluid movement, sleeve inflation, insulation emplacement, and disturbance of the borehole environment, to dissipate so that a baseline temperature field stabilizes prior to active heating.

In some embodiments, waiting for thermal equilibrium to occur includes monitoring temperatures from at least some of the temperature sensors to determine when temperature drift falls below a threshold for a threshold duration. In one non-limiting example, the interrogator or a computing unit determines that thermal equilibrium has occurred when a moving average of measured temperature at a plurality of depths remains within a predefined tolerance band for a predefined time interval. In some embodiments, the equilibrium determination is performed independently for different depths, thereby permitting heating to begin at some depths while waiting continues at other depths.

In one or more embodiments, step 1505 involves activating the array of heating elements to generate a controlled temperature distribution at the borehole sidewall. In one or more embodiments, activating includes causing the heating elements to deliver a predefined amount of thermal energy for a predefined duration so that a repeatable thermal input is applied at known locations. In some embodiments, activating is performed using a power source operable with the heating elements, and the activation pattern is selected to improve identifiability of thermal conductivity and specific heat capacity.

In one non-limiting example, heating elements at a given depth are activated to approximate a point or line heat source on the borehole sidewall, and the resulting temperature response is measured at circumferentially displaced sensor locations to capture both heating rate and heating-front arrival timing. In some embodiments, heating elements are activated sequentially along depth to reduce thermal crosstalk between neighboring heaters, while in other embodiments heating elements are activated simultaneously at multiple depths to reduce total test time. In some embodiments, heating elements are activated in a pulsed sequence, a step-and-hold sequence, or another time-varying pattern that improves inversion stability.

In one or more embodiments, step 1506 involves measuring a time series of temperature data resulting from the heat transfer interactions using the array of temperature sensors. In one or more embodiments, measuring includes querying the temperature sensors with an interrogator to obtain transient temperature responses that include both a heating phase and a cooling phase. In some embodiments, measuring includes acquiring temperature data at multiple depths and at multiple circumferential positions so that the temperature distribution is resolved along a length of the borehole and around a circumference of the borehole.

In one non-limiting example, temperature sensors are arranged such that at least some sensors are positioned nearer to a heating element and at least some other sensors are positioned farther from the heating element, thereby enabling the measured time series to capture differences in heating rate, peak temperature, and time-to-peak temperature that are sensitive to thermal conductivity and specific heat capacity. In some embodiments, the time series is measured at a sampling rate selected to resolve early-time transient behavior while permitting longer-duration monitoring needed to observe cooling dynamics and late-time equilibration.

In one or more embodiments, step 1507 involves quantifying thermal conductivity and specific heat capacity for geologic material of the geologic formation as a function of one or more of a depth within, or a distance along, the borehole using the measured time series of temperature data. In one or more embodiments, quantifying includes applying a numerical inversion method and solving a corresponding mathematical model that includes the thermal conductivity and the specific heat capacity as unknown variables.

In some embodiments, the mathematical model represents conductive heat transport in the geologic formation coupled with reduced heat transport within the insulated borehole interior, thereby reflecting the boundary conditions created by the sleeve and insulating material. In some embodiments, inversion is performed independently for depth intervals corresponding to heater locations so that thermal conductivity and specific heat capacity are determined as depth-resolved parameters.

In other embodiments, inversion is performed jointly across multiple depths to impose smoothness constraints, lithologic priors, or other regularization that improves robustness in noisy field conditions. In one non-limiting example, the computing unit executes an optimization routine that minimizes an objective function defined as a mismatch between measured temperatures and simulated temperatures over time and sensor locations, thereby yielding estimates of thermal conductivity and specific heat capacity at one or more depths.

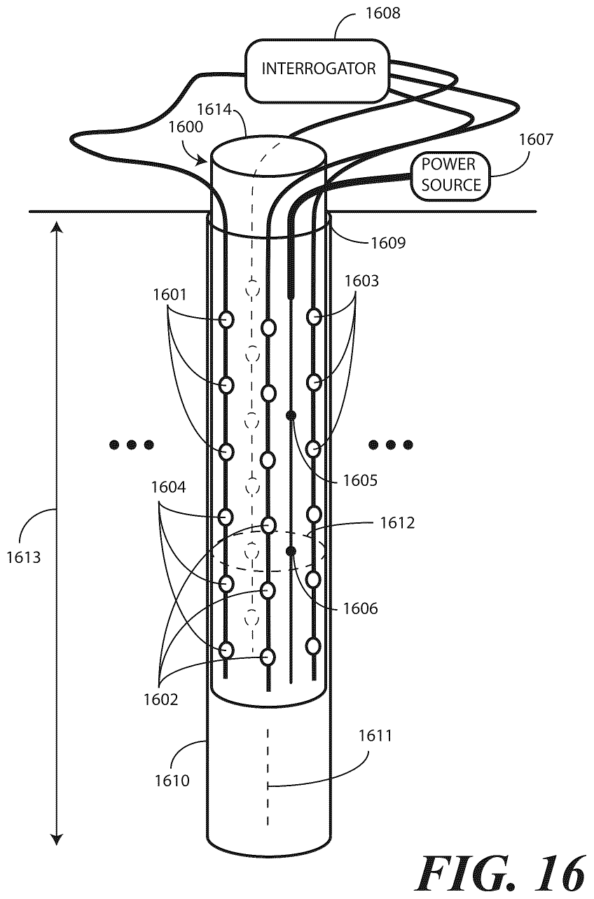

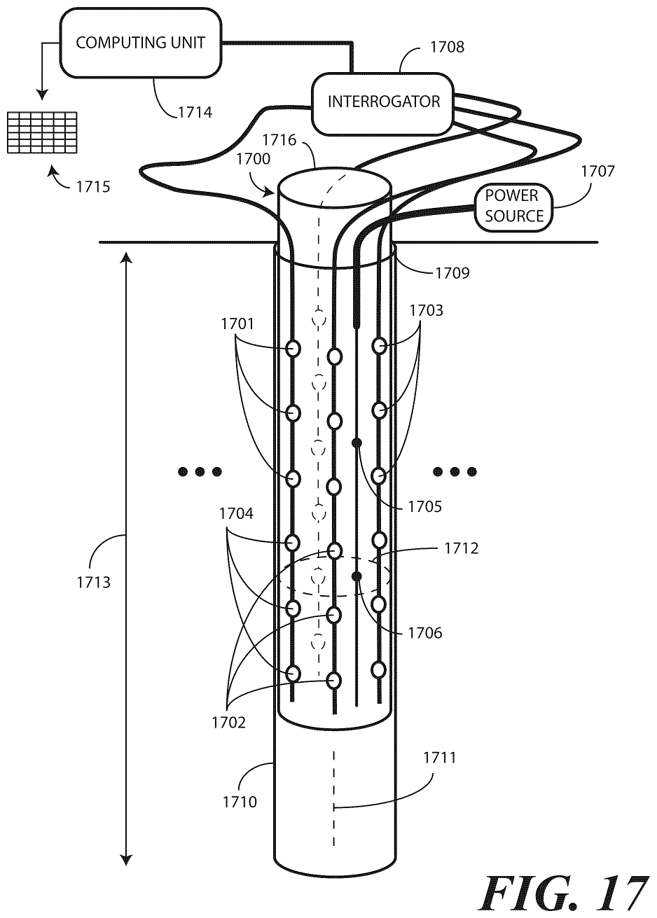

Turning now to FIG. 16, illustrated therein is one explanatory device 1600 in accordance with one or more embodiments of the disclosure. In one or more embodiments, the borehole insertable device housing 1614 serves as the structural framework for the described apparatus, encapsulating all components necessary for precise thermal measurements within subsurface geologic formations. Specifically, in one or more embodiments the housing 1614 is designed for deployment into a borehole 1609 to ensure direct contact with the borehole sidewall 1610, thereby facilitating accurate thermal interaction with the surrounding geologic material.

Under ordinary conditions, the housing 1614 is constructed from durable materials such as steel or reinforced polymers to provide mechanical stability and resistance to environmental degradation under subsurface conditions. Accordingly, the housing 1614 is configured to carry a plurality of temperature sensors 1601-1604 and at least one heater element 1605, ensuring their precise placement and alignment within the borehole 1609.

In one or more embodiments, the borehole insertable device housing 1614 is configured as an inflatable sleeve. The inflatable sleeve is designed to expand and conform to the geometry of the borehole 1609, thereby ensuring consistent contact between the temperature sensors 1601-1604 and the heater element 1605 with the borehole sidewall 1610 and minimizing interference from external factors such as fluid dynamics.

In one or more embodiments, the sleeve is fabricated from flexible materials such as polyethylene or Tyvek.sup.TM, which offer durability, flexibility, and resistance to environmental stressors. For example, the sleeve can be rolled onto a spool for ease of transportation and handling and then unrolled and inserted into the borehole 1609 using a drop weight or other suitable deployment mechanism. Once deployed, the sleeve is inflated with air pressure and filled with insulating material to enhance the precision of thermal measurements.

In one or more embodiments, the plurality of temperature sensors 1601-1604 integrated within the borehole insertable device housing 1614 are significant for capturing high-resolution spatial and temporal temperature data. The temperature sensors 1601-1604 are operatively coupled to an interrogator 1608, which is configured to query each sensor after actuation of the heater element 1605. The sensors 1601-1604 are strategically positioned to measure temperature distributions along both the length and circumference 1612 of the housing 1614, providing comprehensive thermal profiling of the geologic formation.

In some embodiments, the array of temperature sensors 1601-1604 comprises a first set of sensors extending longitudinally along the housing 1614 substantially parallel to the central axis 1611 of the housing and a second set of sensors extending circumferentially around the housing 1614. This configuration enables measurement of temperature distributions both vertically and circumferentially within the depth 1613 of the borehole 1609, supporting depth-resolved and circumferentially resolved characterization of subsurface thermal properties.

In one embodiment, the temperature sensors 1601-1604 are fiber optic sensors defining a fiber Bragg grating (FBG), which offers high precision and sensitivity to temperature changes on the order of millikelvin. Alternatively, the temperature sensors 1601-1604 may include thermistors, platinum resistance thermometers (PRTs), or other suitable sensing technologies, each chosen based on the accuracy, stability, or cost-effectiveness required by the application.

In one or more embodiments, the heater elements 1605,1606 integrated within the borehole insertable device housing 1614 is responsible for generating controlled thermal energy to create localized temperature perturbations at the borehole sidewall 1610. The heater elements 1605,1606 are actuated by a power source 1607, delivering a predefined amount of thermal energy for a predetermined duration.

For example, the heater elements 1605,1606 may comprise a nickel-chromium (NiChrom) wire heating element, which offers high thermal efficiency and durability. In such embodiments, the NiChrom wire is positioned between specific temperature sensors 1601-1604 to ensure direct thermal interaction with the geologic formation. The heater elements 1605,1606 can be activated in various patterns—sequentially along the length of the housing 1614 to create a depth-dependent temperature gradient or simultaneously at multiple locations to generate a circumferential temperature distribution—thereby enabling evaluation of both isotropic and anisotropic thermal properties.

In one or more embodiments, the power source 1607 operable with the heater elements 1605,1606 is designed to provide controlled delivery of electrical energy. The power source 1607 is integrated within the borehole insertable device housing 1614 to ensure reliable operation under subsurface conditions.

In one embodiment, the power source 1607 comprises a rechargeable battery pack for portability and ease of use in field applications. Alternatively, the power source 1607 may include a direct connection to an external power supply, such as a generator or grid power, for extended operation or higher energy output. The power source 1607 is further equipped with control circuitry to regulate energy delivery to the heater elements 1605,1606, thereby ensuring consistent and uniform heating events.

In one or more embodiments, the interrogator 1608 operable with the plurality of temperature sensors 1601,1602,1603, 1604 is responsible for querying each sensor to capture spatial and temporal temperature distributions along the length and circumference 1612 of the borehole insertable device housing 1614. The interrogator 1608 can be integrated within the housing 1614 to enable real-time data acquisition and analysis during thermal measurements.

For example, when interfacing with fiber Bragg grating sensors, the interrogator 1608 may utilize advanced spectrophotometer technology to measure optical wavelength shifts corresponding to temperature variations. Alternatively, the interrogator 1608 may be configured to interface with thermistors or PRTs, providing flexibility for different measurement applications.

In one or more embodiments, the borehole insertable device housing finds application in various use case scenarios:

Residential geothermal heat pump systems: In suburban settings, the device can be deployed to characterize thermal properties of shallow soil layers up to depths of 30 meters, optimizing small-scale heat pump designs.

Commercial and industrial projects: For large-scale geothermal systems, deployment in fractured bedrock formations at depths up to three kilometers supports design and optimization of borehole heat exchangers with extended power and data acquisition capabilities.

Research applications: Academic and industrial researchers can employ the device to study thermal behavior of diverse geologic formations—such as sandy soils, clay layers, or granite—using high-precision sensors and advanced numerical inversion methods.

Monitoring of borehole heat exchangers: By incorporating a heat exchanger within the instrumented sleeve and filling the borehole with thermal grout, the device enables long-term evaluation of exchanger performance and thermal resistance.

Anisotropic thermal property evaluation: Activation of the heater element to generate circumferential temperature distributions allows characterization of anisotropic thermal properties in heterogeneous formations.

Forced convection analysis: Inclusion of a small, short-duration heater and symmetric sensor array permits assessment of convective heat transfer, as evidenced by differential temperature rise rates in downstream versus upstream directions.

Rapid site assessments: The modular design of the housing and sleeve facilitates rapid scoping of shallow vertical boreholes or trenched pipe-coil installations in urban and suburban environments, thereby enhancing economic feasibility and scalability.

Turning now to FIG. 17, illustrated therein is one explanatory system in accordance with one or more embodiments of the disclosure. In one or more embodiments, the system comprises a device 1700, a power source 1707, an interrogator 1708, and a computing device 1714. Since the device 1700 is configured for precision thermal property measurements in subsurface geologic formations, the device is borehole-insertable and deployable into a borehole 1709, where the device engages directly with the borehole sidewall 1710.

In one or more embodiments, the device 1700 integrates temperature sensors 1701,1702,1703, 1704, heating elements 1705 and 1706, and an inflatable sleeve 1716. Accordingly, when positioned against the borehole sidewall 1710, the device 1700 measures temperature distributions both along the length and around the circumference 1712 of the borehole 1709, thereby enabling depth-resolved and circumferentially resolved characterization of thermal conductivity and specific heat capacity parameters 1715 of the surrounding formation.

In some embodiments, the temperature sensors 1701-1704 are arranged along both the longitudinal axis and the circumference of the device 1700 and are operatively coupled to an interrogator 1708. In one or more embodiments, the interrogator 1708 queries each sensor to capture spatial and temporal temperature distributions resulting from activation of the heating elements 1705,1706.

In one or more embodiments, these sensors are fiber optic sensors defining a fiber Bragg grating (FBG) that extends parallel to the central axis 1711 of the inflatable sleeve 1716. Furthermore, the sensors are arranged in at least two columns, with at least two sensors per column at radially displaced locations about the circumference of device 1700, thereby ensuring high-resolution thermal measurements.

In one or more embodiments, the heating elements 1705 and 1706 are integrated into the inflatable sleeve 1716 and situated between selected temperature sensors 1701-1704 to generate controlled thermal energy at the borehole sidewall 1710. The heating elements 1705,1706 are actuated by a power source 1707 to deliver a predefined energy pulse for a predefined duration. As a result, direct thermal interaction is established with the geologic formation, facilitating accurate determination of thermal conductivity and specific heat capacity parameters 1715.

In some embodiments, the inflatable sleeve 1716 is fabricated from durable, flexible materials such as polyethylene or Tyvek.sup.TM and is configured to conform to the geometry of the borehole 1709. Accordingly, the sleeve 1716 maintains consistent contact between temperature sensors 1701-1704, heating elements 1705,1706, and the borehole sidewall 1710, while minimizing interference from borehole fluids. In one or more embodiments, the fiber optic FBG sensor and heating elements are sandwiched between two sheets of sleeve material and oriented parallel to the central axis 1711 of the sleeve.

In one or more embodiments, the power source 1707 is operable with heating elements 1705,1706 and provides controlled electrical energy to generate thermal perturbations. For example, the power source 1707 may comprise a rechargeable battery pack for field portability or alternatively, a direct connection to an external power supply such as a generator or grid power. In one or more embodiments, the power source 1707 includes control circuitry to regulate energy delivery to the heating elements 1705,1706, thereby ensuring uniform and repeatable heating events under subsurface conditions.

In some embodiments, the interrogator 1708 is integrated within the system and is configured to interrogate temperature sensors 1701-1704 in real time. For example, when interfacing with fiber Bragg grating sensors, the interrogator 1708 employs spectrophotometer technology to measure optical wavelength shifts corresponding to temperature variations. The interrogator 1708 then transmits the captured data to the computing unit 1714 for further analysis.

In one or more embodiments, the borehole 1709 is a vertical or inclined cylindrical excavation in the geologic formation, into which the device 1700 is deployed. The borehole sidewall 1710 serves as the primary interface for thermal interaction between heating elements 1705,1706 and the surrounding formation. The borehole 1709 can extend from shallow soil layers to depths of up to three kilometers below the surface, with the depth 1713 representing the vertical distance measured from the surface.

The central axis 1711 represents the longitudinal axis of both the borehole 1709 and the inflatable sleeve 1716. Accordingly, the temperature sensors 1701-1704 and heating elements 1705,1706 are aligned along this axis, ensuring precise positioning for accurate thermal measurements.

The depth 1713 is an important parameter for depth-resolved characterization of thermal conductivity and specific heat capacity parameters 1715 of the geologic formation. In one or more embodiments, the thermal conductivity parameters and specific heat capacity parameters 1715 are determined by analyzing temperature data captured by sensors 1701-1704 in response to controlled heating events. The data are processed using advanced numerical inversion methods to quantify the thermal properties of the formation adjacent to the borehole 1709.

In some embodiments, the computing unit 1714 is configured to receive temperature data from the interrogator 1708 and execute numerical inversion algorithms to determine thermal conductivity and specific heat capacity parameters 1715. The computing unit 1714 applies advanced mathematical models to analyze the time-series temperature data, solving for the thermal properties as unknown variables. The computing unit 1714 plays a significant role in providing accurate and reliable subsurface thermal property measurements.

One of ordinary skill in the art having the benefit of this disclosure appreciates that various modifications and changes can be made without departing from the scope of the present disclosure. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, in various embodiments the system for evaluating ground thermophysical properties can be adapted to include different configurations and materials for the inflatable sleeve, heating elements, and fiber optic sensors. For instance, the inflatable sleeve may be constructed from polyethylene, Tyvek.sup.TM, or other durable, flexible materials capable of withstanding subsurface conditions, such as high pressure or varying temperatures.

The fiber optic sensor defining the fiber Bragg grating may be replaced or supplemented with other high-precision temperature sensors, such as thermistors or resistance temperature detectors (RTDs), to accommodate different measurement requirements or cost constraints. The heating element may be implemented using nickel-chromium wire, carbon-based heating elements, or other resistive heating materials, and may be arranged in various configurations, such as linear, coiled, or bundled, to optimize heat distribution.

The power source could range from a battery pack to a direct connection to an external power supply, depending on the depth and duration of the test. The interrogator may utilize different technologies, such as spectrophotometers or wavelength division multiplexing, to query the fiber Bragg grating or other sensors.

Additionally, the system may include variations in the placement of the heating elements and sensors, such as alternating or staggered arrangements along the sleeve, to enhance the resolution of thermal property measurements. The inflatable sleeve may also be filled with different insulating materials, such as expanded perlite, sand, or thermal grout, to minimize heat loss and improve measurement accuracy. Furthermore, the system may be designed for deployment in boreholes of varying diameters and depths, ranging from shallow soil borings to deep rock formations, to accommodate diverse geological conditions.

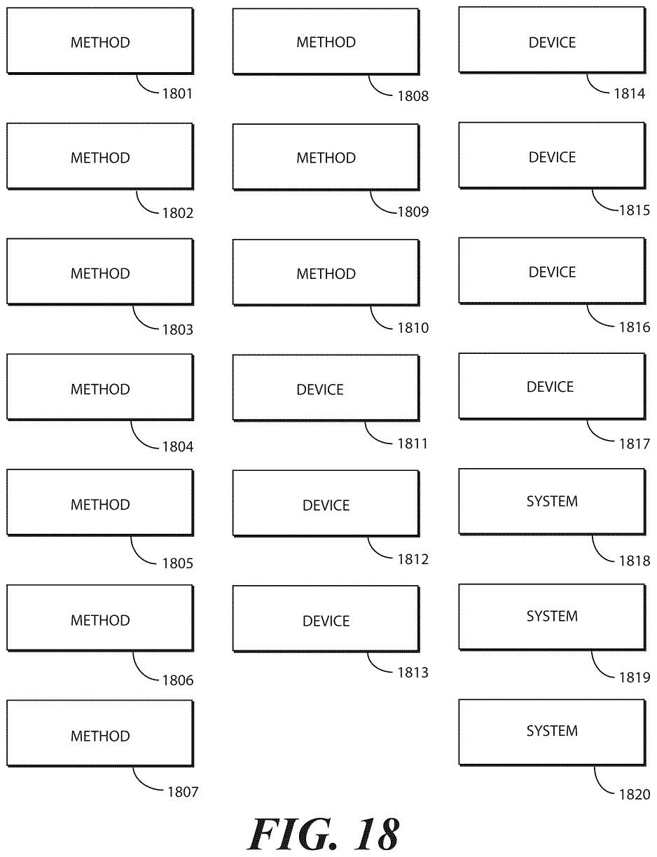

Turning now to FIG. 18, illustrated therein are various embodiments of the disclosure. The embodiments of FIG. 18 are shown as labeled boxes in FIG. 18 due to the fact that the individual components of these embodiments have been illustrated in detail in FIGS. 13-16, which precede FIG. 18. Accordingly, since these items have previously been illustrated and described, their repeated illustration is no longer essential for a proper understanding of these embodiments. Thus, the embodiments are shown as labeled boxes.

At 1801, a method for quantifying thermal properties of a geologic formation comprises deploying, into a borehole located at a measurement site of the geologic formation, an array of temperature sensors and an array of heating elements encapsulated in a sleeve, activating the array of heating elements to generate a resulting temperature distribution at a sidewall of the borehole, and measuring a time series of measurements of the resulting temperature distribution using the array of temperature sensors. At 1802, the method of 1801 further comprises deploying another array of temperature sensors and another array of heating elements into the borehole with the array of temperature sensors and the array of heating elements. At 1802, the activating of 1801 results in an application of thermal energy to the sidewall by the array of heating elements and the another array of heating elements and the measuring of 1801 uses both the array of temperature sensors and the another array of temperature sensors to obtain the time series of measurements.

At 1803, the method of 1802 further comprises quantifying a thermal conductivity and specific heat capacity for geologic material of the geologic formation as a function of one or more of a depth within, or a distance along, the borehole using the time series of measurements. At 1804, the thermal conductivity of 1803 and the specific heat capacity are quantified simultaneously for portions of the geologic formation situated adjacent to the borehole.

At 1805, the method of 1801 further comprises a sleeve carrying the array of temperature sensors and the array of heating elements. At 1805, the array of temperature sensors comprises a plurality of temperature sensors comprising a first set of temperature sensors extending along the sleeve substantially parallel to a central axis of the sleeve and a second set of temperature sensors extending around a circumference of the sleeve. At 1805, the array of heating elements comprises a plurality of heating elements extending along the sleeve substantially parallel to the central axis of the sleeve. At 1805, the deploying comprises positioning both the plurality of temperature sensors and the plurality of heating elements against the sidewall of the borehole at depths within the borehole of between zero and three kilometers, inclusive, below a surface of the geologic formation.

At 1806, the method of 1801 further comprises a sleeve carrying the array of temperature sensors and the array of heating elements. At 1806, the array of temperature sensors comprises a plurality of temperature sensors. At 1806, the array of heating elements comprises a plurality of heating elements, with the plurality of temperature sensors and the plurality of heating elements positioned at predetermined locations and intervals along the sleeve such that heating events generated by the activating the array of heating elements occur at discrete locations occurring at predefined distances along the borehole.

At 1807, the activating the array of heating elements of 1801 comprises causing the array of heating elements to deliver a predefined amount of thermal energy to the sidewall for a predefined duration. At 1808, the measuring the time series of measurements of 1807 occurs after thermal perturbations within the borehole at the sidewall caused by the deploying have equilibrated.

At 1809, the method of 1801 further comprises quantifying a thermal conductivity and specific heat capacity for portions of the geologic formation situated adjacent to the borehole by applying a numerical inversion method and solving a corresponding mathematical model that includes the thermal conductivity and the specific heat capacity as unknown variables. At 1810, the method of 1801 further comprises, after the deploying and before the activating, placing an insulating material in the borehole atop or around the array of temperature sensors and the array of heating elements.

At 1811, a device comprises a plurality of temperature sensors and at least one heater element carried by a borehole insertable device housing. At 1811, the device comprises a power source operable with the at least one heater element and an interrogator operable with the plurality of temperature sensors. At 1811, the interrogator is configured to query each temperature sensor of the plurality of temperature sensors after the power source actuates the at least one heater element for a predefined duration to determine a temperature distribution along a length of, and around a circumference of, the borehole insertable device housing.

At 1812, the borehole insertable device housing of 1811 comprises an inflatable sleeve. At 1813, each temperature sensor of 1812 comprises a fiber optic sensor such that the plurality of temperature sensors defines a fiber Bragg grating.

At 1814, the at least one heater element of 1813 comprises a wire heating element. At 1815, the wire heating element of 1814 and the fiber optic sensor defining the fiber Bragg grating extend along a length of the inflatable sleeve parallel to a central axis of the inflatable sleeve.

At 1816, the plurality of temperature sensors of 1813 comprises at least two columns with at least two temperature sensors in each column. At 1816, the at least two columns are arranged along lengths of the borehole insertable device housing at radially displaced locations about the circumference of the borehole insertable device housing from the at least one heating element. At 1817, the device of 1811 further comprises at least one other temperature sensor that is displaced from the at least one heater element on the borehole insertable device housing.

At 1818, a system for evaluating ground thermophysical properties comprises an inflatable sleeve carrying a fiber optic sensor defining a fiber Bragg grating extending along a length of the inflatable sleeve parallel to a central axis of the inflatable sleeve, at least one heating element situated along the inflatable sleeve such that the at least one heating element is situated between at least some optical fiber sensors of the fiber Bragg grating and at least some other optical fiber sensors of the fiber Bragg grating, a power source operable with the at least one heating element, and an interrogator operable with the fiber Bragg grating. At 1818, the interrogator is configured to query the fiber Bragg grating after the power source actuates the at least one heating element to determine a temperature distribution along the length of, and around a circumference of, the inflatable sleeve.

At 1819, the inflatable sleeve of 1818 is positioned within a borehole defined by a geologic formation. At 1819, the system further comprises a computing unit configured to receive temperature data from the interrogator and execute a numerical inversion method to determine thermal conductivity parameters and specific heat capacity parameters of portions of the geologic formation positioned against the inflatable sleeve.

At 1820, the inflatable sleeve of 1818 is manufactured from at least two sheets of polyethylene. At 1820, the at least one heating element is manufactured from nickel-chromium wire. At 1820, the nickel-chromium wire and the fiber optic sensor are sandwiched between a pair of sheets of the at least two sheets of polyethylene and oriented parallel with a central axis of the inflatable sleeve.

Thus, as illustrated and described, a method and apparatus for quantifying thermal conductivity and specific heat capacity of subsurface geologic formations includes a deployable borehole package comprising an inflatable sleeve encapsulating an array of one or more temperature sensors and one or more heating elements. Upon deployment into a borehole, the one or more heating elements generate a controlled temperature distribution at the borehole sidewall, while the one or more temperature sensors measure a time series of temperature data.

One or more processors apply advanced numerical inversion methods to analyze the time series temperature data and, in response to the inversion results, determine thermal conductivity and specific heat capacity with high precision and depth resolution. Accordingly, the system eliminates the need for completed borehole heat exchangers, reduces testing time, and provides reliable, cost-effective measurements applicable to various geologic formations, wherein principal applications include geothermal heat pump system design, subsurface thermal profiling, and geologic research.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, in one embodiment the system includes an inflatable sleeve constructed from polyethylene sheets, which are bonded or welded to encapsulate the fiber optic sensors and heating elements. The fiber optic sensors may be arranged in a single column or multiple columns along the length of the sleeve, with each column containing discrete sensors spaced at predetermined intervals to ensure precise temperature measurements.

In another embodiment, the heating elements are composed of bundled nickel-chromium wire, which may be configured as continuous linear sources or discrete point sources to optimize heat distribution. The sleeve may be filled with insulating materials such as expanded perlite or sand to minimize heat loss and ensure accurate thermal conductivity measurements.

In yet another embodiment, the interrogator is designed to operate with fiber Bragg gratings, enabling high-resolution temperature data collection, while the computing unit employs advanced numerical inversion methods to calculate thermal conductivity and specific heat capacity parameters. The system may also include additional sensors, such as thermistors, positioned radially around the heating elements to capture circumferential temperature variations. Furthermore, the sleeve can be adapted for deployment in various borehole depths, ranging from shallow residential applications to deep geothermal projects, with lengths extending up to three kilometers.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

The detailed description set forth above provides illustrative embodiments of the disclosed subject matter, which pertains to the field of geothermal energy technologies, specifically methods and apparatuses for quantifying subsurface thermal properties such as thermal conductivity and specific heat capacity. The disclosed subject matter addresses challenges in accurately characterizing ground thermophysical properties to optimize the design, scaling, and monitoring of borehole heat exchangers for geothermal heat pump systems.

By leveraging advanced instrumentation and modeling techniques, the disclosed subject matter offers a streamlined approach to obtaining reliable, depth-resolved thermal data. The embodiments described herein are provided for illustrative purposes only and are not intended to limit the scope of the subject matter disclosed. Certain well-known principles, components, and methods may not be described in detail to avoid obscuring the subject matter, as they will be readily understood by those skilled in the art.

Furthermore, the disclosed subject matter encompasses various modifications, rearrangements, and alternative implementations that fall within the scope of the claims, including variations in sensor configurations, heating element designs, and deployment methods. The examples provided herein are intended to demonstrate the principles and advantages of the disclosed subject matter, and the scope of the subject matter is to be determined solely by the claims appended hereto.

What is claimed is:

1. A method for quantifying thermal properties of a geologic formation, the method comprising:
deploying, into a borehole located at a measurement site of the geologic formation, an array of temperature sensors and an array of heating elements encapsulated in a sleeve;
activating the array of heating elements to generate a resulting temperature distribution at a sidewall of the borehole; and
measuring a time series of measurements of the resulting temperature distribution using the array of temperature sensors.

2. The method of claim 1, further comprising deploying another array of temperature sensors and another array of heating elements into the borehole with the array of temperature sensors and the array of heating elements, wherein:
the activating results in an application of thermal energy to the sidewall by the array of heating elements and the another array of heating elements; and
the measuring uses both the array of temperature sensors and the another array of temperature sensors to obtain the time series of measurements.

3. The method of claim 2, further comprising quantifying a thermal conductivity and specific heat capacity for geologic material of the geologic formation as a function of one or more of a depth within, or a distance along, the borehole using the time series of measurements.

4. The method of claim 3, wherein the thermal conductivity and the specific heat capacity are quantified simultaneously for portions of the geologic formation situated adjacent to the borehole.

5. The method of claim 1, wherein:
a sleeve carries the array of temperature sensors and the array of heating elements;
the array of temperature sensors comprises a plurality of temperature sensors comprising a first set of temperature sensors extending along the sleeve substantially parallel to a central axis of the sleeve and a second set of temperature sensors extending around a circumference of the sleeve;
the array of heating elements comprises a plurality of heating elements extending along the sleeve substantially parallel to the central axis of the sleeve; and
the deploying comprises positioning both the plurality of temperature sensors and the plurality of heating elements against the sidewall of the borehole at depths within the borehole of between zero and three kilometers, inclusive, below a surface of the geologic formation.

6. The method of claim 1, wherein:
a sleeve carrying the array of temperature sensors and the array of heating elements; and
the array of temperature sensors comprises a plurality of temperature sensors, the array of heating elements comprises a plurality of heating elements, with the plurality of temperature sensors and the plurality of heating elements positioned at predetermined locations and intervals along the sleeve such that heating events generated by the activating the array of heating elements occur at discrete locations occurring at predefined distances along the borehole.

7. The method of claim 1, wherein the activating the array of heating elements comprises causing the array of heating elements to deliver a predefined amount of thermal energy to the sidewall for a predefined duration.

8. The method of claim 7, wherein the measuring the time series of measurements occurs after thermal perturbations within the borehole at the sidewall caused by the deploying have equilibrated.

9. The method of claim 1, further comprising quantifying a thermal conductivity and specific heat capacity for portions of the geologic formation situated adjacent to the borehole by applying a numerical inversion method and solving a corresponding mathematical model that includes the thermal conductivity and the specific heat capacity as unknown variables.

10. The method of claim 1, further comprising, after the deploying and before the activating, placing an insulating material in the borehole atop or around the array of temperature sensors and the array of heating elements.

11. A device, comprising:
a plurality of temperature sensors and at least one heater element carried by a borehole insertable device housing;
a power source operable with the at least one heater element; and
an interrogator operable with the plurality of temperature sensors;
wherein the interrogator is configured to query each temperature sensor of the plurality of temperature sensors after the power source actuates the at least one heater element for a predefined duration to determine a temperature distribution along a length of, and around a circumference of, the borehole insertable device housing.

12. The device of claim 11, wherein the borehole insertable device housing comprises an inflatable sleeve.

13. The device of claim 12, wherein the each temperature sensor comprises a fiber optic sensor such that the plurality of temperature sensors define a fiber Bragg grating.

14. The device of claim 13, wherein the at least one heater element comprises a wire heating element.

15. The device of claim 14, wherein the wire heating element and the fiber optic sensor defining the fiber Bragg grating extend along a length of the inflatable sleeve parallel to a central axis of the inflatable sleeve.

16. The device of claim 13, wherein:
the plurality of temperature sensors comprise at least two columns with at least two temperature sensors in each column; and
the at least two columns are arranged along lengths of the borehole insertable device housing at radially displaced locations about the circumference of the borehole insertable device housing from the at least one heating element.

17. The device of claim 11, further comprising at least one other temperature sensor that is displaced from the at least one heater element on the borehole insertable device housing.

18. A system for evaluating ground thermophysical properties, the system comprising:
an inflatable sleeve carrying a fiber optic sensor defining a fiber Bragg grating extending along a length of the inflatable sleeve parallel to a central axis of the inflatable sleeve;
at least one heating element situated along the inflatable sleeve such that the at least one heating element is situated between at least some optical fiber sensors of the fiber Bragg grating and at least some other optical fiber sensors of the fiber Bragg grating;
a power source operable with the at least one heating element; and
an interrogator operable with the fiber Bragg grating;
wherein the interrogator is configured to query the fiber Bragg grating after the power source actuates the at least one heating element to determine a temperature distribution along the length of, and around a circumference of, the inflatable sleeve.

19. The system of claim 18, wherein the inflatable sleeve is positioned within a borehole defined by a geologic formation, further comprising a computing unit configured to receive temperature data from the interrogator and execute a numerical inversion method to determine thermal conductivity parameters and specific heat capacity parameters of portions of the geologic formation positioned against the inflatable sleeve.

20. The system of claim 18, wherein:
the inflatable sleeve is manufactured from at least two sheets of polyethylene;
the at least one heating element is manufactured from nickel-chromium wire; and
the nickel-chromium wire and the fiber optic sensor are sandwiched between a pair of sheets of the at least two sheets of polyethylene and oriented parallel with a central axis of the inflatable sleeve.
